(19) United States
(12) Patent Application Publication
(10) Pub. No.: US 2023/0117399 A1
(43) Pub. Date: Apr. 20, 2023

(54) Systems and Methods for Assessing Content Similarity in NFT-Directed Environments

(71) Applicant: Artema Labs, Inc, Los Angeles, CA (US)

(72) Inventors: Bjorn Markus Jakobsson, Portola Valley, CA (US); Perry Raymond Cook, Jacksonville, OR (US); Rebecca Anne Fiebrink, London (GB)

(73) Assignee: Artema Labs, Inc, Los Angeles, CA (US)

(21) Appl. No.: 18/047,244

(22) Filed: Oct. 17, 2022

Related U.S. Application Data
(60) Provisional application No. 63/256,600, filed on Oct. 17, 2021.
(60) Provisional application No. 63/300,600, filed on Jan. 18, 2022.

(51) Int. Cl. G06Q 50/18

(52) U.S. Cl. CPC G06Q 50/184

(57) ABSTRACT

Systems and techniques for license management within an NFT platform are illustrated. One embodiment includes a method for assessing content similarity including: receiving a record associated with a first content element, wherein the first content element has an exclusion distance; generating a second content description from the second content element, deriving a comparison distance between the first quantifier and the second quantifier; and when the comparison distance exceeds the exclusion distance, taking a remedial action for infringement.

### CROSS-REFERENCE TO RELATED APPLICATIONS

The current application claims the benefit of and priority under 35 U.S.C. § 119(e) to U.S. Provisional Patent Application No. 63/256,600, titled “Content Similarity Detection and Prevention Mechanism,” filed Oct. 17, 2021, and U.S. Provisional Patent Application No. 63/300,600, titled “Rights Management for Audio-Visual Content on the Media Chain,” filed Jan. 18, 2022, the disclosures of which are hereby incorporated by reference in their entireties for all purposes.

### FIELD OF THE INVENTION

The present invention generally relates to systems and methods directed to assessing licensing and/or royalty requirements initiated in response to content similarity.

### BACKGROUND

Non-fungible tokens (NFTs) and other forms of tokens representing content, along with token-based derived works and configurable royalty and licensing policies, have the capability to bolster a number of industries including but not limited to art, music, and textual creations. Token royalties and licensing requirements may be applied to stimulate the creation of art and content. Within token-directed environments, resale of tokens may enable content creators to obtain royalties for future sales of content they have created. Further, licensing obligations to content creators may govern the use of content sufficiently similar to the output of those creators.

### SUMMARY OF THE INVENTION

Systems and techniques for license management within an NFT platform are illustrated. One embodiment includes a method for assessing content similarity. The method receives a record associated with a first content element, wherein the first content element has an exclusion distance; wherein the record comprises a first content description and a license indicator, and wherein the first content description comprises a type indicator for the first content element and a first quantifier of the first content element. The method receives a second content element. The method generates a second content description from the second content element, wherein a type indicator for the second content element and a second quantifier of the second content element. The method derives a comparison distance between the first quantifier and the second quantifier. When the exclusion distance exceeds the comparison distance, the method takes a remedial action for infringement.

In another embodiment, the remedial action is at least one of requiring a license to be created, blocking generation of a token from the second content element, updating a record for the second content element, limiting access to the second content element, initiating a review of the first and second content elements by an administrator, and allowing generation of a token from the second content element with an indication of the infringement.

In a further embodiment, the remedial action is determined in an automated process.

In another embodiment, a quantifier is at least one of a vector representation of a content element and a string.

In another embodiment, the license indicator comprises terms associated with using the first content element.

In yet another embodiment, type indicators correspond to classifications related to at least one of audio data, visual data and executable data.

In another embodiment, a quantifier is based, at least in part, on at least one of content volume, content colors, content rate, and content functionality.

In another embodiment, both the comparison distance and the exclusion distance are at least one of a vector distance and a Hamming distance.

In still another embodiment, the exclusion distance at least one of a value preset by an entity associated with the first content element and a value stored in the record.

In another embodiment, when the exclusion distance does not exceed the comparison distance, the method associates the second content element with at least one of: a verification that a license is not required; and a second exclusion distance.

One embodiment includes non-transitory computer-readable medium storing instructions that, when executed by a processor, are configured to cause the processor to perform operations for assessing content similarity. The processor receives a record associated with a first content element, wherein the first content element has an exclusion distance; wherein the record comprises a first content description and a license indicator, and wherein the first content description comprises a type indicator for the first content element and a first quantifier of the first content element. The processor receives a second content element. The processor generates a second content description from the second content element, wherein a type indicator for the second content element and a second quantifier of the second content element. The processor derives a comparison distance between the first quantifier and the second quantifier. When the exclusion distance exceeds the comparison distance, the processor takes a remedial action for infringement.

In another embodiment, the remedial action is at least one of requiring a license to be created, blocking generation of a token from the second content element, updating a record for the second content element, limiting access to the second content element, initiating a review of the first and second content elements by an administrator, and allowing generation of a token from the second content element with an indication of the infringement.

In a further embodiment, the remedial action is determined in an automated process.

In another embodiment, a quantifier is at least one of a vector representation of a content element and a string.

In another embodiment, the license indicator comprises terms associated with using the first content element.

In yet another embodiment, type indicators correspond to classifications related to at least one of audio data, visual data and executable data.

In another embodiment, a quantifier is based, at least in part, on at least one of content volume, content colors, content rate, and content functionality.

In another embodiment, both the comparison distance and the exclusion distance are at least one of a vector distance and a Hamming distance.

In still another embodiment, the exclusion distance at least one of a value preset by an entity associated with the first content element and a value stored in the record.

In another embodiment, when the exclusion distance does not exceed the comparison distance, the processor associates the second content element with at least one of: a verification that a license is not required; and a second exclusion distance.

### BRIEF DESCRIPTION OF THE DRAWINGS

The description and claims will be more fully understood with reference to the following figures and data graphs, which are presented as exemplary embodiments of the invention and should not be construed as a complete recitation of the scope of the invention.

FIG. 1 is a conceptual diagram of an NFT platform in accordance with an embodiment of the invention.

FIG. 2 is a network architecture diagram of an NFT platform in accordance with an embodiment of the invention.

FIG. 3 is a conceptual diagram of a permissioned blockchain in accordance with an embodiment of the invention.

FIG. 4 is a conceptual diagram of a permissionless blockchain in accordance with an embodiment of the invention.

FIGS. 5A-5B are diagrams of a dual blockchain in accordance with a number of embodiments of the invention.

FIG. 6 conceptually illustrates a process followed by a Proof of Work consensus mechanism in accordance with an embodiment of the invention.

FIG. 7 conceptually illustrates a process followed by a Proof of Space consensus mechanism in accordance with an embodiment of the invention.

FIG. 8 illustrates a dual proof consensus mechanism configuration in accordance with an embodiment of the invention.

FIG. 9 illustrates a process followed by a Trusted Execution Environment-based consensus mechanism in accordance with some embodiments of the invention.

FIGS. 10-12 depicts various devices that can be utilized alongside an NFT platform in accordance with various embodiments of the invention.

FIG. 13 depicts a media wallet application configuration in accordance with an embodiment of the invention.

FIGS. 14A-14C depicts user interfaces of various media wallet applications in accordance with a number of embodiments of the invention.

FIG. 15 illustrates an NFT ledger entry corresponding to an NFT identifier in accordance with several embodiments of the invention.

FIGS. 16A-16B illustrate an NFT arrangement relationship with corresponding physical content in accordance with some embodiments of the invention.

FIG. 17 illustrates a process for establishing a relationship between an NFT and corresponding physical content in accordance with a number of embodiments of the invention.

FIGS. 18A-18B illustrate representations of an application configuration operating in accordance with many embodiments of the invention.

FIG. 19 illustrates vectorized descriptions generated in accordance with numerous embodiments of the invention.

FIG. 20 illustrates an example database record in accordance with many embodiments of the invention.

FIG. 21 conceptually illustrates a process, for the determination of whether a new content element requires a license, in accordance with various embodiments of the invention.

FIG. 22 conceptually illustrates a process for determining whether any license is needed for the distribution of content in accordance with some embodiments of the invention.

### DETAILED DESCRIPTION

Systems and methods for incorporating transaction-directed functionalities into non-fungible token (NFT) platforms, in accordance with many embodiments of the invention, are described herein. License-directed functionality may include, but is not limited to configurations enabling determinations of similarity between content elements and search capabilities applicable to potentially infringing content elements.

NFT platforms in accordance with a number of embodiments of the invention may implement various mechanisms to assess content similarity. Mechanisms may classify content based on classifications including but not limited to medium (e.g, audio file, video file, still image). Mechanisms may be applied to the vectorization of content within particular classifications, describing characteristics of content elements using one or more vector elements. Vector elements may correspond to features including but not limited to volume for audio files, color scales for audiovisual files, FFTs for still images, etc. Comparisons of vector elements may be utilized by systems operating in accordance with many embodiments of the invention to assess when various such elements fall into individualized exclusion zones of particular pieces of content. In accordance with some embodiments, exclusion zones may reflect particular degrees of similarity, within which, a license for the corresponding content is required. Exclusion may be dependent on, but not limited to, user settings, the popularity of particular content types, and/or mediums of use. NFT platforms in accordance with a few embodiments of the invention may, additionally or alternatively, incorporate similarity assessments to enable public database scans/searches for intellectual property infringement. Such searches may be performed on content elements and/or sub-elements/sub-components. Upon determining that content exceeds particular levels of similarity, systems operating in accordance with some embodiments may invoke licensing and/or royalty requirements.

While various token and system configurations are discussed above, licensing-based functionalities that can be utilized within NFT platforms in accordance with various embodiments of the invention are discussed further below.

### Non-Fungible Token (NFT) Platforms

Turning now to the drawings, systems and methods for implementing blockchain-based Non-Fungible Token (NFT) platforms in accordance with various embodiments of the invention are illustrated. In accordance with several embodiments, blockchain-based NFT platforms are platforms which enable content creators to issue, mint, and transfer Non-Fungible Tokens (NFTs) directed to content including, but not limited to, rich media content.

In a number of embodiments, content creators can issue NFTs to users within the NFT platform. NFTs can be created around a large range of real-world media content and intellectual property. Movie studios can mint digital collectibles for their movies, characters, notable scenes and/or notable objects. Record labels can mint digital collectibles for artists, bands, albums and/or songs. Similarly, official digital trading cards can be made from likeness of celebrities, cartoon characters and/or gaming avatars.

NFTs minted using NFT platforms in accordance with various embodiments of the invention can have multifunctional programmable use cases including rewards, private access to premium content and experiences, as discounts toward the purchase of goods, among many other value-added use cases.

In accordance with many embodiments, each NFT can have a set of attributes that define its unique properties. NFTs may therefore be classified based on which attributes are emphasized. Possible classifications may address, but are not limited to: NFTs as identifying entities, NFTs output by other NFTs, NFTs as content creation assets, and NFTs as evaluating entities. NFTs can be interpreted differently by various platforms in order to create platform-specific user experiences. The metadata associated with an NFT may also include digital media assets such as (but not limited to) images, videos about the specific NFT, and the context in which it was created (studio, film, band, company song etc.).

In accordance with many embodiments, NFT storage may be facilitated through mechanisms for the transfer of payment from users to one or more service providers. Through these mechanisms, a payment system for NFT maintenance can allow for incremental payment and ongoing asset protection. NFT storage may be additionally self-regulated through willing participants disclosing unsatisfactory NFT management in exchange for rewards.

In accordance with many embodiments, the NFT platform can include media wallet applications that enable users to securely store NFTs and/or other tokens on their devices. Furthermore, media wallets (also referred to as “digital wallets”) can enable users to obtain NFTs that prove purchase of rights to access a particular piece of media content on one platform and use the NFT to gain access to the purchased content on another platform. The consumption of such content may be governed by content classification directed to visual user interface systems.

In accordance with several embodiments, users can download and install media wallet applications to store NFTs on the same computing devices used to consume streamed and/or downloaded content. Media wallet applications and NFTs can disseminate data concerning media consumption on the computing devices on which the media wallet applications are installed and/or based upon observations indicative of media consumption independently of the device. Media consumption data may include, but is not limited to, data reporting the occurrence of NFT transactions, data reporting the occurrence of NFT event interactions data reporting the content of NFT transactions, data reporting the content of media wallet interactions, and/or data reporting the occurrence of media wallet interactions.

While various aspects of NFT platforms, NFTs, media wallets, blockchain configurations, reporting structures, and maintenance systems are discussed above, NFT platforms and different components that can be utilized within NFT platforms in accordance with various embodiments of the invention are discussed further below.

### NFT Platforms

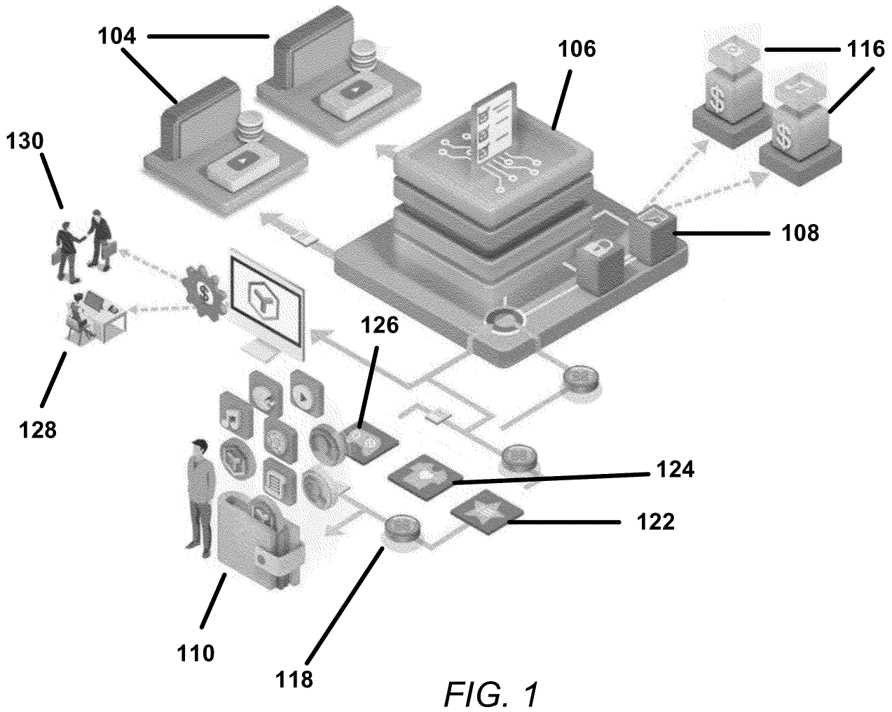

An NFT platform in accordance with an embodiment of the invention is illustrated in FIG. 1. The NFT platform 100 utilizes one or more immutable ledgers (e.g. one or more blockchains) to enable a number of verified content creators 104 to access an NFT registry service to mint NFTs 106 in a variety of forms including (but not limited to) celebrity NFTs 122, character NFTs from games 126, NFTs that are redeemable within games 126, NFTs that contain and/or enable access to collectibles 124, and NFTs that have evolutionary capabilities representative of the change from one NFT state to another NFT state.

Issuance of NFTs 106 via the NFT platform 100 enables verification of the authenticity of NFTs independently of the content creator 104 by confirming that transactions written to one or more of the immutable ledgers are consistent with the smart contracts 108 underlying the NFTs.

As is discussed further below, content creators 104 can provide the NFTs 106 to users to reward and/or incentivize engagement with particular pieces of content and/or other user behavior including (but not limited to) the sharing of user personal information (e.g. contact information or user ID information on particular services), demographic information, and/or media consumption data with the content creator and/or other entities. In addition, the smart contracts 108 underlying the NFTs can cause payments of residual royalties 116 when users engage in specific transactions involving NFTs (e.g. transfer of ownership of the NFT).

In a number of embodiments, users utilize media wallet applications 110 on their devices to store NFTs 106 distributed using the NFT platform 100. Users can use media wallet applications 110 to obtain and/or transfer NFTs 106. In facilitating the retention or transfer of NFTs 106, media wallet applications may utilize wallet user interfaces that engage in transactional restrictions through either uniform or personalized settings. Media wallet applications 110 in accordance with some embodiments may incorporate NFT filtering systems to avoid unrequested NFT assignment. Methods for increased wallet privacy may also operate through multiple associated wallets with varying capabilities. As can readily be appreciated, NFTs 106 that are implemented using smart contracts 108 having interfaces that comply with open standards are not limited to being stored within media wallets and can be stored in any of a variety of wallet applications as appropriate to the requirements of a given application. Furthermore, a number of embodiments of the invention support movement of NFTs 106 between different immutable ledgers. Processes for moving NFTs between multiple immutable ledgers in accordance with various embodiments of the invention are discussed further below.

In accordance with several embodiments, content creators 104 can incentivize users to grant access to media consumption data using offers including (but not limited to) offers of fungible tokens 118 and/or NFTs 106. In this way, the ability of the content creators to mint NFTs enables consumers to engage directly with the content creators and can be utilized to incentivize users to share with content creators’ data concerning user interactions with additional content. The permissions granted by individual users may enable the content creators 104 to directly access data written to an immutable ledger. In accordance with many embodiments, the permissions granted by individual users enable authorized computing systems to access data within an immutable ledger and content creators 104 can query the authorized computing systems to obtain aggregated information. Numerous other example functions for content creators 104 are possible, some of which are discussed below.

NFT blockchains in accordance with various embodiments of the invention enable issuance of NFTs by verified users. In accordance with many embodiments, the verified users can be content creators that are vetted by an administrator of networks that may be responsible for deploying and maintaining the NFT blockchain. Once the NFTs are minted, users can obtain and conduct transactions with the NFTs. In accordance with several embodiments, the NFTs may be redeemable for items or services in the real world such as (but not limited to) admission to movie screenings, concerts, and/or merchandise.

As illustrated in FIG. 1, users can install the media wallet application 110 onto their devices and use the media wallet application 110 to purchase fungible tokens. The media wallet application could also be provided by a browser, or by a dedicated hardware unit executing instructions provided by a wallet manufacturer. The different types of wallets may have slightly different security profiles and may offer different features, but would all be able to be used to initiate the change of ownership of tokens, such as NFTs. In accordance with many embodiments, the fungible tokens can be fully converted into fiat currency and/or other cryptocurrency. In accordance with several embodiments, the fungible tokens are implemented using split blockchain models in which the fungible tokens can be issued to multiple blockchains (e.g. Ethereum). As can readily be appreciated, the fungible tokens and/or NFTs utilized within an NFT platform in accordance with various embodiments of the invention are largely dependent upon the requirements of a given application.

In accordance with several embodiments, the media wallet application is capable of accessing multiple blockchains by deriving accounts from each of the various immutable ledgers used within an NFT platform. For each of these blockchains, the media wallet application can automatically provide simplified views whereby fungible tokens and NFTs across multiple accounts and/or multiple blockchains can be rendered as single user profiles and/or wallets. In accordance with many embodiments, the single view can be achieved using deep-indexing of the relevant blockchains and API services that can rapidly provide information to media wallet applications in response to user interactions. In certain embodiments, the accounts across the multiple blockchains can be derived using BIP32 deterministic wallet key. In other embodiments, any of a variety of techniques can be utilized by the media wallet application to access one or more immutable ledgers as appropriate to the requirements of a given application.

NFTs can be purchased by way of exchanges 130 and/or from other users 128. In addition, content creators can directly issue NFTs to the media wallets of specific users (e.g. by way of push download or AirDrop). In accordance with many embodiments, the NFTs are digital collectibles such as celebrity NFTs 122, character NFTs from games 126, NFTs that are redeemable within games 126, and/or NFTs that contain and/or enable access to collectibles 124. It should be appreciated that a variety of NFTs are described throughout the discussion of the various embodiments described herein and can be utilized in any NFT platform and/or with any media wallet application.

While the NFTs are shown as static in the illustrated embodiment, content creators can utilize users’ ownership of NFTs to engage in additional interactions with the users. In this way, the relationship between users and particular pieces of content and/or particular content creators can evolve over time around interactions driven by NFTs. In a number of embodiments, collection of NFTs can be gamified to enable unlocking of additional NFTs. In addition, leaderboards can be established with respect to particular content and/or franchises based upon users’ aggregation of NFTs. As is discussed further below, NFTs and/or fungible tokens can also be utilized by content creators to incentivize users to share data.

NFTs minted in accordance with several embodiments of the invention may incorporate a series of instances of digital content elements in order to represent the evolution of the digital content over time. Each one of these digital elements can have multiple numbered copies, just like a lithograph, and each such version can have a serial number associated with it, and/or digital signatures authenticating its validity. The digital signature can associate the corresponding image to an identity, such as the identity of the artist. The evolution of digital content may correspond to the transition from one representation to another representation. This evolution may be triggered by the artist, by an event associated with the owner of the artwork, by an external event measured by platforms associated with the content, and/or by specific combinations or sequences of event triggers. Some such NFTs may also have corresponding series of physical embodiments. These may be physical and numbered images that are identical to the digital instances described above. They may also be physical representations of another type, e.g., clay figures or statues, whereas the digital representations may be drawings. The physical embodiments may further be of different aspects that relate to the digital series. Evolution in compliance with some embodiments may also be used to spawn additional content, for example, one NFT directly creating one or more secondary NFTs.

When users wish to purchase NFTs using fungible tokens, media wallet applications can request authentication of the NFTs directly based upon the public key of the content creators and/or indirectly based upon transaction records within the NFT blockchain. As discussed above, minted NFTs can be signed by content creators and administrators of the NFT blockchain. In addition, users can verify the authenticity of particular NFTs without the assistance of entities that minted the NFT by verifying that the transaction records involving the NFT within the NFT blockchain are consistent with the various royalty payment transactions required to occur in conjunction with transfer of ownership of the NFT by the smart contract underlying the NFT.

Applications and methods in accordance with various embodiments of the invention are not limited to media wallet applications or use within NFT platforms. Accordingly, it should be appreciated that the data collection capabilities of any media wallet application described herein can also be implemented outside the context of an NFT platform and/or in a dedicated application and/or in an application unrelated to the storage of fungible tokens and/or NFTs. Various systems and methods for implementing NFT platforms and media wallet applications in accordance with various embodiments of the invention are discussed further below.

### NFT Platform Network Architectures

NFT platforms in accordance with many embodiments of the invention utilize public blockchains and permissioned blockchains. In accordance with several embodiments, the public blockchain is decentralized and universally accessible. Additionally, in a number of embodiments, private/permissioned blockchains are closed systems that are limited to publicly inaccessible transactions. In accordance with many embodiments, the permissioned blockchain can be in the form of distributed ledgers, while the blockchain may alternatively be centralized in a single entity.

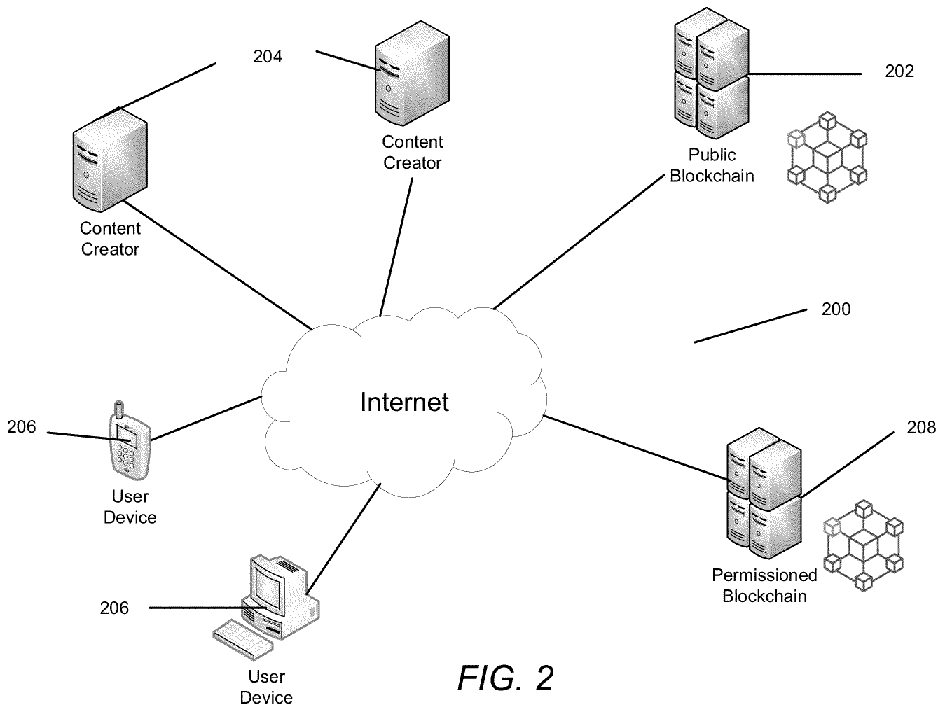

An example of network architecture that can be utilized to implement an NFT platform including a public blockchain and a permissioned blockchain in accordance with several embodiments of the invention is illustrated in FIG. 2. The NFT platform 200 utilizes computer systems implementing a public blockchain 202 such as (but not limited to) Ethereum and Solana. A benefit of supporting interactions with public blockchains 202 is that the NFT platform 200 can support minting of standards based NFTs that can be utilized in an interchangeable manner with NFTs minted by sources outside of the NFT platform on the public blockchain. In this way, the NFT platform 200 and the NFTs minted within the NFT platform are not part of a walled garden, but are instead part of a broader blockchain-based ecosystem. The ability of holders of NFTs minted within the NFT platform 200 to transact via the public blockchain 202 increases the likelihood that individuals acquiring NFTs will become users of the NFT platform. Initial NFTs minted outside the NFT platform can also be developed through later minted NFTs, with the initial NFTs being used to further identify and interact with users based upon their ownership of both NFTs. Various systems and methods for facilitating the relationships between NFTs, both outside and within the NFT platform are discussed further below.

Users can utilize user devices configured with appropriate applications including (but not limited to) media wallet applications to obtain NFTs. In accordance with many embodiments, media wallets are smart device enabled, front-end applications for fans and/or consumers, central to all user activity on NFT platforms. As is discussed in detail below, different embodiments of media wallet applications can provide any of a variety of functionality that can be determined as appropriate to the requirements of a given application. In the illustrated embodiment, the user devices 206 are shown as mobile phones and personal computers. As can readily be appreciated user devices can be implemented using any class of consumer electronics device including (but not limited to) tablet computers, laptop computers, televisions, game consoles, virtual reality headsets, mixed reality headsets, augmented reality headsets, media extenders, and/or set top boxes as appropriate to the requirements of a given application.

In accordance with many embodiments, NFT transaction data entries in the permissioned blockchain 208 are encrypted using users’ public keys so that the NFT transaction data can be accessed by the media wallet application. In this way, users control access to entries in the permissioned blockchain 208 describing the users’ NFT transactions. In accordance with several embodiments, users can authorize content creators 204 to access NFT transaction data recorded within the permissioned blockchain 208 using one of a number of appropriate mechanisms including (but not limited to) compound identities where the user is the owner of the data and the user can authorize other entities as guests that can also access the data. As can readily be appreciated, particular content creators’ access to the data can be revoked by revoking their status as guests within the compound entity authorized to access the NFT transaction data within the permissioned blockchain 208. In certain embodiments, compound identities are implemented by writing authorized access records to the permissioned blockchain using the user’s public key and the public keys of the other members of the compound entity.

When content creators wish to access particular pieces of data stored within the permissioned blockchain 208, they can make a request to a data access service. The data access service may grant access to data stored using the permissioned blockchain 208 when the content creators’ public keys correspond to public keys of guests. In a number of embodiments, guests may be defined within a compound identity. The access record for the compound entity may also authorize the compound entity to access the particular piece of data. In this way, the user has complete control over access to their data at any time by admitting or revoking content creators to a compound entity, and/or modifying the access policies defined within the permissioned blockchain 208 for the compound entity. In accordance with several embodiments, the permissioned blockchain 208 supports access control lists and users can utilize a media wallet application to modify permissions granted by way of the access control list. In accordance with many embodiments, the manner in which access permissions are defined enables different restrictions to be placed on particular pieces of information within a particular NFT transaction data record within the permissioned blockchain 208. As can readily be appreciated, the manner in which NFT platforms and/or immutable ledgers provide fine-grained data access permissions largely depends upon the requirements of a given application.

In accordance with many embodiments, storage nodes within the permissioned blockchain 208 do not provide content creators with access to entire NFT transaction histories. Instead, the storage nodes simply provide access to encrypted records. In accordance with several embodiments, the hash of the collection of records from the permissioned blockchain is broadcast. Therefore, the record is verifiably immutable and each result includes the hash of the record and the previous/next hashes. As noted above, the use of compound identities and/or access control lists can enable users to grant permission to decrypt certain pieces of information or individual records within the permissioned blockchain. In accordance with several embodiments, the access to the data is determined by computer systems that implement permission-based data access services.

In accordance with many embodiments, the permissioned blockchain 208 can be implemented using any blockchain technology appropriate to the requirements of a given application. As noted above, the information and processes described herein are not limited to data written to permissioned blockchains 208, and NFT transaction data simply provides an example. Systems and methods in accordance with various embodiments of the invention can be utilized to enable applications to provide fine-grained permission to any of a variety of different types of data stored in an immutable ledger as appropriate to the requirements of a given application in accordance with various embodiments of the invention.

While various implementations of NFT platforms are described above with reference to FIG. 2, NFT platforms can be implemented using any number of immutable and pseudo-immutable ledgers as appropriate to the requirements of specific applications in accordance with various embodiments of the invention. Blockchain databases in accordance with various embodiments of the invention may be managed autonomously using peer-to-peer networks and distributed timestamping servers. In accordance with some embodiments, any of a variety of consensus mechanisms may be used by public blockchains, including (but not limited to) Proof of Space mechanisms, Proof of Work mechanisms, Proof of Stake mechanisms, and hybrid mechanisms.

NFT platforms in accordance with many embodiments of the invention may benefit from the oversight and increased security of private blockchains. As can readily be appreciated, a variety of approaches can be taken to the writing of data to permissioned blockchains and the particular approach is largely determined by the requirements of particular applications. As such, computer systems in accordance with various embodiments of the invention can have the capacity to create verified NFT entries written to permissioned blockchains.

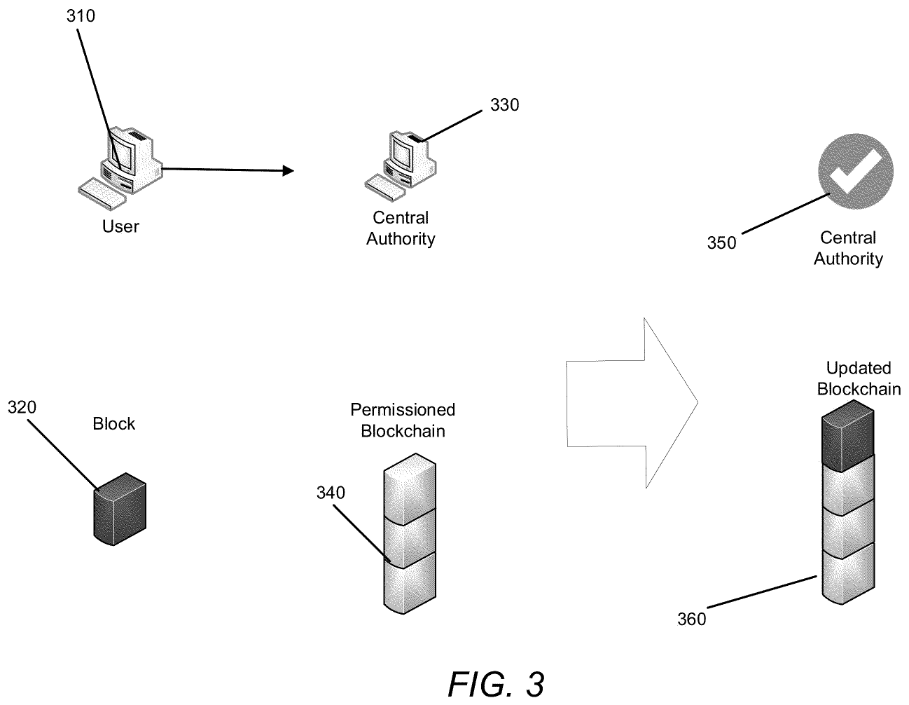

An implementation of permissioned (or private) blockchains in accordance with some embodiments of the invention is illustrated in FIG. 3. Permissioned blockchains 340 can typically function as closed computing systems in which each participant is well defined. In accordance with several embodiments, private blockchain networks may require invitations. In a number of embodiments, entries, or blocks 320, to private blockchains can be validated. In some embodiments, the validation may come from central authorities 330. Private blockchains can allow an organization or a consortium of organizations to efficiently exchange information and record transactions. Specifically, in a permissioned blockchain, a preapproved central authority 330 (which should be understood as potentially encompassing multiple distinct authorized authorities) can approve a change to the blockchain. In a number of embodiments, approval may come without the use of a consensus mechanism involving multiple authorities. As such, through a direct request from users 310 to the central authority 330, the determination of whether blocks 320 can be allowed access to the permissioned blockchain 340 can be determined. Blocks 320 needing to be added, eliminated, relocated, and/or prevented from access may be controlled through these modes. In doing so the central authority 330 may manage accessing and controlling the network blocks incorporated into the permissioned blockchain 340. Upon the approval 350 of the central authority, the now updated blockchain 360 can reflect the added block 320.

NFT platforms in accordance with many embodiments of the invention may also benefit from the anonymity and accessibility of a public blockchain. Therefore, NFT platforms in accordance with many embodiments of the invention can have the capacity to create verified NFT entries written to a permissioned blockchain.

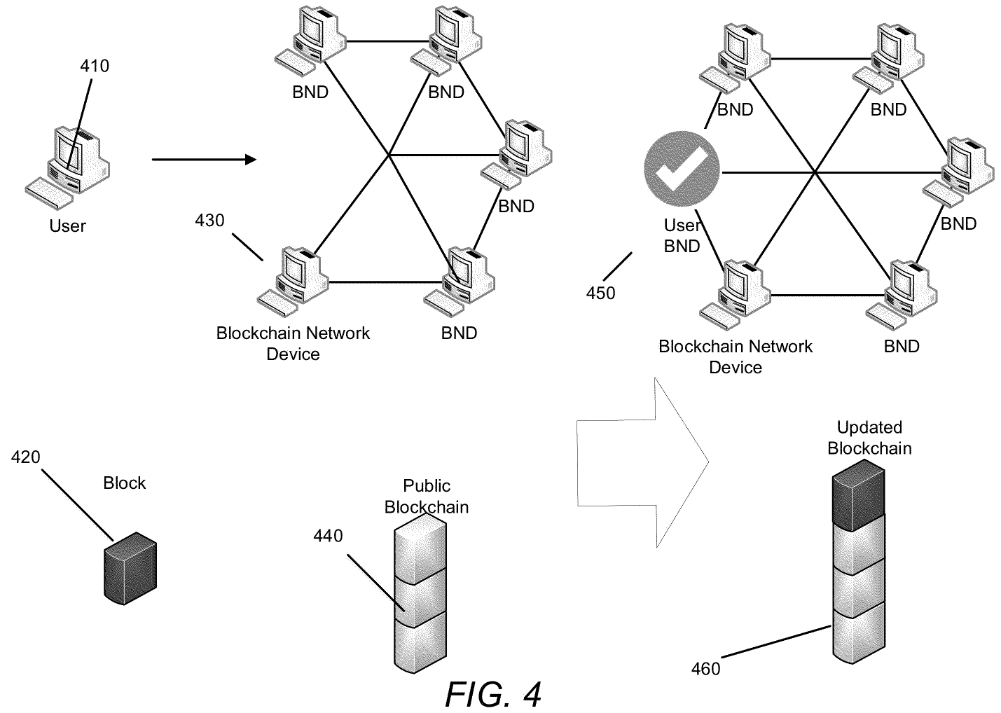

An implementation of a permissionless, decentralized, or public blockchain in accordance with an embodiment of the invention is illustrated in FIG. 4. In a permissionless blockchain, individual users 410 can directly participate in relevant networks and operate as blockchain network devices 430. As blockchain network devices 430, parties would have the capacity to participate in changes to the blockchain and participate in transaction verifications (via the mining mechanism). Transactions are broadcast over the computer network and data quality is maintained by massive database replication and computational trust. Despite being decentralized, an updated blockchain 460 cannot remove entries, even if anonymously made, making it immutable. In accordance with many decentralized blockchains, many blockchain network devices 430, in the decentralized system may have copies of the blockchain, allowing the ability to validate transactions. In accordance with many instances, the blockchain network device 430 can personally add transactions, in the form of blocks 420 appended to the public blockchain 440. To do so, the blockchain network device 430 would take steps to allow for the transactions to be validated 450 through various consensus mechanisms (Proof of Work, Proof of Stake, etc.). A number of consensus mechanisms in accordance with various embodiments of the invention are discussed further below.

Additionally, in the context of blockchain configurations, the term smart contract is often used to refer to software programs that run on blockchains. While a standard legal contract outlines the terms of a relationship (usually one enforceable by law), a smart contract enforces a set of rules using self-executing code within NFT platforms. As such, smart contracts may have the modes to automatically enforce specific programmatic rules through platforms. Smart contracts are often developed as high-level programming abstractions that can be compiled down to bytecode. Said bytecode may be deployed to blockchains for execution by computer systems using any number of mechanisms deployed in conjunction with the blockchain. In accordance with many instances, smart contracts execute by leveraging the code of other smart contracts in a manner similar to calling upon a software library.

A number of existing decentralized blockchain technologies intentionally exclude or prevent rich media assets from existing within the blockchain, because they would need to address content that is not static (e.g., images, videos, music files). Therefore, NFT platforms in accordance with many embodiments of the invention may address this with blockchain mechanisms, that preclude general changes but account for updated content.

NFT platforms in accordance with many embodiments of the invention can therefore incorporate decentralized storage pseudo-immutable dual blockchains. In accordance with some embodiments, two or more blockchains may be interconnected such that traditional blockchain consensus algorithms support a first blockchain serving as an index to a second, or more, blockchains serving to contain and protect resources, such as the rich media content associated with NFTs.

In storing rich media using blockchain, several components may be utilized by an entity (“miner”) adding transactions to said blockchain. References, such as URLs, may be stored in the blockchain to identify assets. Multiple URLs may also be stored when the asset is separated into pieces. An alternative or complementary option may be the use of APIs to return either the asset or a URL for the asset. In accordance with many embodiments of the invention, references can be stored by adding a ledger entry incorporating the reference enabling the entry to be timestamped. In doing so, the URL, which typically accounts for domain names, can be resolved to IP addresses. However, when only files of certain types are located on particular resources, or where small portions of individual assets are stored at different locations, users may require methods to locate assets stored on highly-splintered decentralized storage systems. To do so, systems may identify at least primary asset destinations and update those primary asset destinations as necessary when storage resources change. The mechanisms used to identify primary asset destinations may take a variety of forms including, but not limited to, smart contracts.

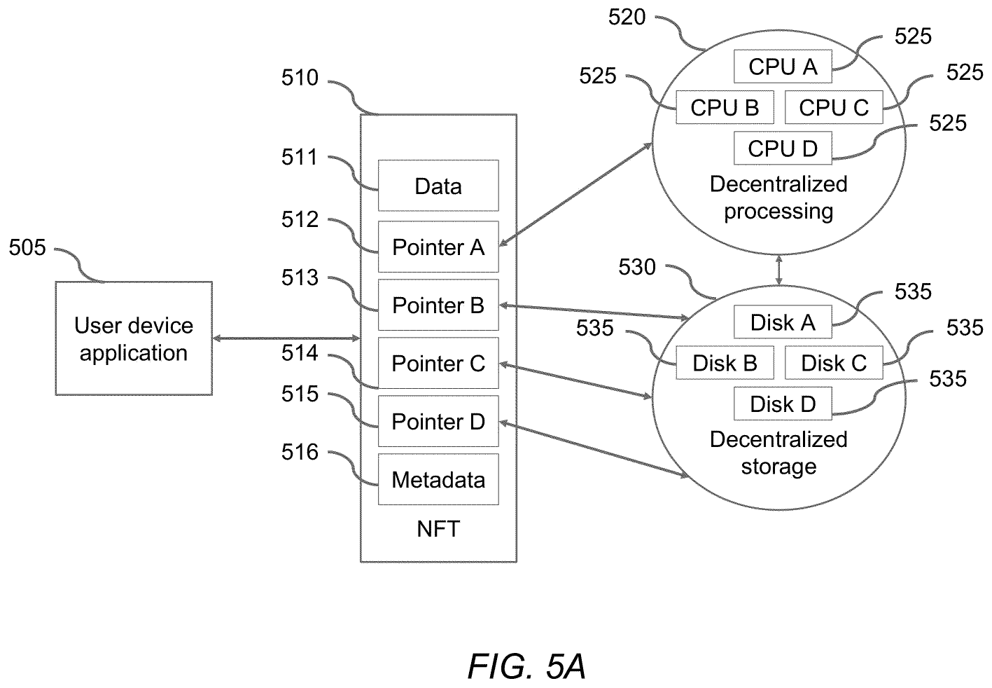

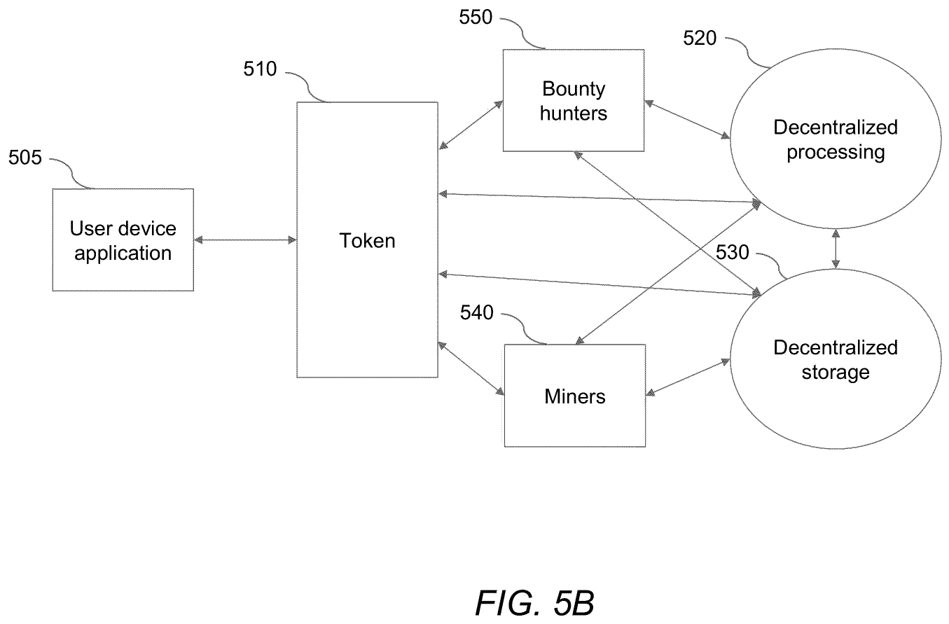

A dual blockchain, including decentralized processing 520 and decentralized storage 530 blockchains, in accordance with some embodiments of the invention is illustrated in FIG. 5A. Application running on devices 505, may interact with or make a request related to NFTs 510 interacting with such a blockchain. An NFT 510 in accordance with several embodiments of the invention may include many values including generalized data 511 (e.g. URLs), and pointers such as pointer A 512, pointer B 513, pointer C 514, and pointer D 515. In accordance with many embodiments of the invention, the generalized data 511 may be used to access corresponding rich media through the NFT 510. The NFT 510 may additionally have associated metadata 516.

Pointers within the NFT 510 may direct an inquiry toward a variety of on or off-ledger resources. In accordance with some embodiments of the invention, as illustrated FIG. 5A, pointer A 512 can direct the need for processing to the decentralized processing network 520. Processing systems are illustrated as CPU A, CPU B, CPU C, and CPU D 525. The CPUs 525 may be personal computers, server computers, mobile devices, edge loT devices, etc. Pointer A may select one or more processors at random to perform the execution of a given smart contract. The code may be secure or nonsecure and the CPU may be a trusted execution environment (TEE) depending upon the needs of the request. In the example reflected in FIG. 5A, pointer B 513, pointer C 514, and pointer D 515 all point to a decentralized storage network 530 including remote off-ledger resources including storage systems illustrated as Disks A, B, C, and D 535.

The decentralized storage system may co-mingle with the decentralized processing system as the individual storage systems utilize CPU resources and connectivity to perform their function. From a functional perspective, the two decentralized systems may also be separate. Pointer B 513 may point to one or more decentralized storage networks 530 for the purposes of maintaining an off-chain log file of token activity and requests. Pointer C 514 may point to executable code within one or more decentralized storage networks 530. And Pointer D 515 may point to rights management data, security keys, and/or configuration data within one or more decentralized storage networks 530.

Dual blockchains may additionally incorporate methods for detection of abuse, essentially operating as a “bounty hunter” 550. FIG. 5B illustrates the inclusion of bounty hunters 550 within dual blockchain structures implemented in accordance with an embodiment of the invention. Bounty hunters 550 allow NFTs 510, which can point to networks that may include decentralized processing 520 and/or storage networks 530, to be monitored. The bounty hunter’s 550 objective may be to locate incorrectly listed or missing data and executable code within the NFT 510 or associated networks. Additionally, the miner 540 can have the capacity to perform all necessary minting processes or any process within the architecture that involves a consensus mechanism.

Bounty hunters 550 may also choose to verify each step of a computation, and if they find an error, submit evidence of this in return for some reward. This can have the effect of invalidating the incorrect ledger entry and, potentially based on policies, all subsequent ledger entries. Such evidence can be submitted in a manner that is associated with a public key, in which the bounty hunter 550 proves knowledge of the error, thereby assigning value (namely the bounty) with the public key.

Assertions made by bounty hunters 550 may be provided directly to miners 540 by broadcasting the assertion. Assertions may be broadcast in a manner including, but not limited to posting it to a bulletin board. In accordance with some embodiments of the invention, assertions may be posted to ledgers of blockchains, for instance, the blockchain on which the miners 540 operate. If the evidence in question has not been submitted before, this can automatically invalidate the ledger entry that is proven wrong and provide the bounty hunter 550 with some benefit.

Applications and methods in accordance with various embodiments of the invention are not limited to use within NFT platforms. Accordingly, it should be appreciated that the capabilities of any blockchain configuration described herein can also be implemented outside the context of an NFT platform network architecture unrelated to the storage of fungible tokens and/or NFTs. A variety of components, mechanisms, and blockchain configurations that can be utilized within NFT platforms are discussed further below. Moreover, any of the blockchain configurations described herein with reference to FIG. 3-5B (including permissioned, permissionless, and/or hybrid mechanisms) can be utilized within any of the networks implemented within the NFT platforms described above.

### NFT Platform Consensus Mechanisms

NFT platforms in accordance with many embodiments of the invention can depend on consensus mechanisms to achieve agreement on network state, through proof resolution, to validate transactions. In accordance with many embodiments of the invention, Proof of Work (PoW) mechanisms may be used as a mode of demonstrating non-trivial allocations of processing power. Proof of Space (PoS) mechanisms may be used as a mode of demonstrating non-trivial allocations of memory or disk space. As a third possible approach, Proof of Stake mechanisms may be used as a mode of demonstrating non-trivial allocations of fungible tokens and/or NFTs as a form of collateral. Numerous consensus mechanisms are possible in accordance with various embodiments of the invention, some of which are expounded on below.

Traditional mining schemes, such as Bitcoin, are based on Proof of Work, based on performing the aforementioned large computational tasks. The cost of such tasks may not only be computational effort, but also energy expenditure, a significant environmental concern. To address this problem, mining methods operating in accordance with many embodiments of the invention may instead operate using Proof of Space mechanisms to accomplish network consensus, wherein the distinguishing factor can be memory rather than processing power. Specifically, Proof of Space mechanisms can perform this through network optimization challenges. In accordance with several embodiments the network optimization challenge may be selected from any of a number of different challenges appropriate to the requirements of specific applications including graph pebbling. In accordance with some embodiments, graph pebbling may refer to a resource allocation game played on discrete mathematics graphs, ending with a labeled graph disclosing how a player might get at least one pebble to every vertex of the graph.

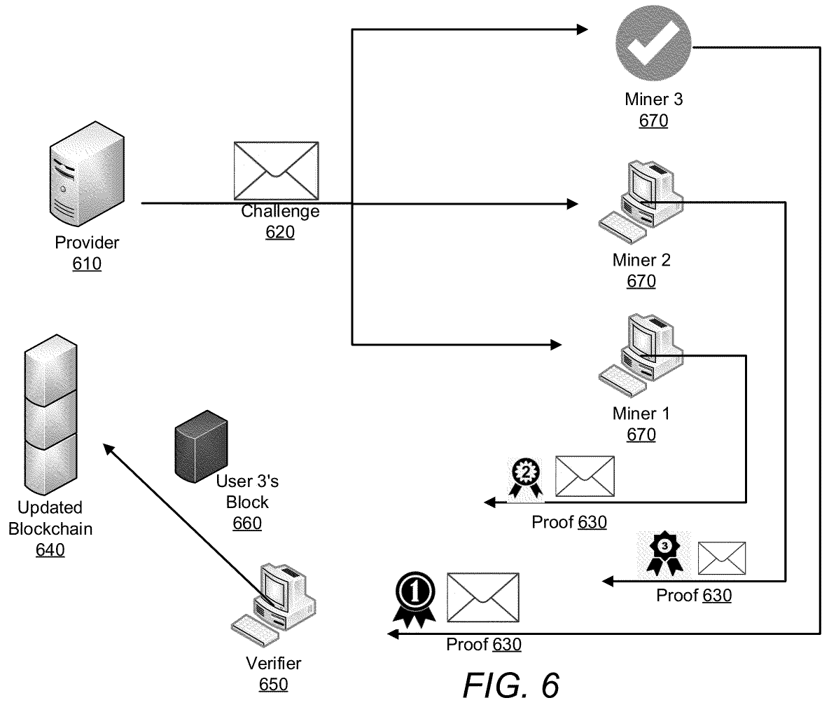

An example of Proof of Work consensus mechanisms that may be implemented in decentralized blockchains, in accordance with a number of embodiments of the invention, is conceptually illustrated in FIG. 6. The example disclosed in this figure is a challenge-response authentication, a protocol classification in which one party presents a complex problem (“challenge”) 610 and another party must broadcast a valid answer (“proof”) 620 to have clearance to add a block to the decentralized ledger that makes up the blockchain 630. As a number of miners may be competing to have this ability, there may be a need for determining factors for the addition to be added first, which in this case is processing power. Once an output is produced, verifiers 640 in the network can verify the proof, something which typically requires much less processing power, to determine the first device that would have the right to add the winning block 650 to the blockchain 630. As such, under a Proof of Work consensus mechanism, each miner involved can have a success probability proportional to the computational effort expended.

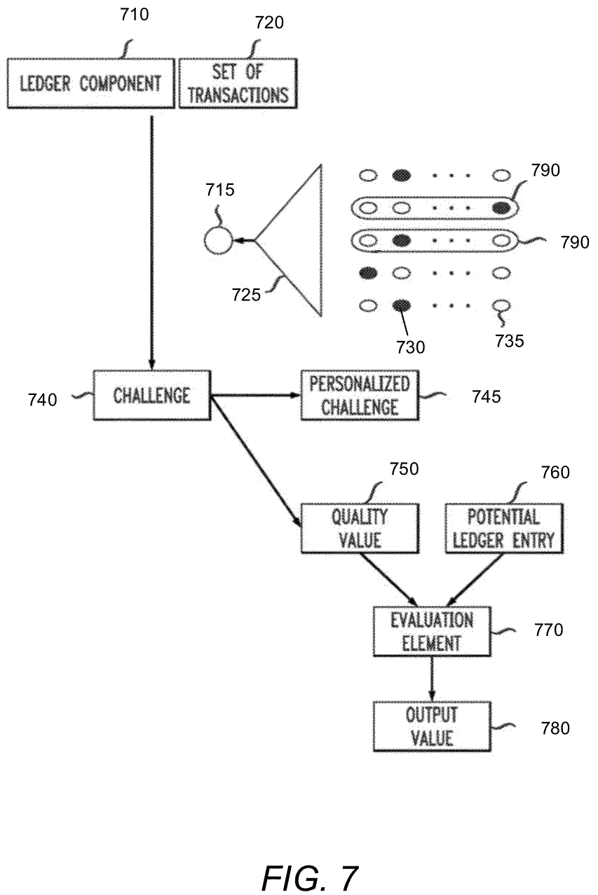

An example of Proof of Space implementations on devices in accordance with some embodiments of the invention is conceptually illustrated in FIG. 7. The implementation includes a ledger component 710, a set of transactions 720, and a challenge 740 computed from a portion of the ledger component 710. A representation 715 of a miner’s state may also be recorded in the ledger component 710 and be publicly available.

In accordance with some embodiments, the material stored on the memory of the device includes a collection of nodes 730, 735, where nodes that depend on other nodes have values that are functions of the values of the associated nodes on which they depend. For example, functions may be one-way functions, such as cryptographic hash functions. In accordance with several embodiments the cryptographic hash function may be selected from any of a number of different cryptographic hash functions appropriate to the requirements of specific applications including (but not limited to) the SHA1 cryptographic hash function. In such an example, one node in the network may be a function of three other nodes. Moreover, the node may be computed by concatenating the values associated with these three nodes and applying the cryptographic hash function, assigning the result of the computation to the node depending on these three parent nodes. In this example, the nodes are arranged in rows, where two rows 790 are shown. The nodes are stored by the miner, and can be used to compute values at a setup time. This can be done using Merkle tree hash-based data structures 725, or another structure such as a compression function and/or a hash function.

Challenges 740 may be processed by the miner to obtain personalized challenges 745, made to the device according to the miner’s storage capacity. The personalized challenge 745 can be the same or have a negligible change, but could also undergo an adjustment to account for the storage space accessible by the miner, as represented by the nodes the miner stores. For example, when the miner does not have a large amount of storage available or designated for use with the Proof of Space system, a personalized challenge 745 may adjust challenges 740 to take this into consideration, thereby making a personalized challenge 745 suitable for the miner’s memory configuration.

In accordance with some embodiments, the personalized challenge 745 can indicate a selection of nodes 730, denoted in FIG. 7 by filled-in circles. In the FIG. 7 example specifically, the personalized challenge corresponds to one node per row. The collection of nodes selected as a result of computing the personalized challenge 745 can correspond to a valid potential ledger entry 760. However, here a quality value 750 (also referred to herein as a qualifying function value) can also be computed from the challenge 740, or from other public information that is preferably not under the control of any one miner.

A miner may perform matching evaluations 770 to determine whether the set of selected nodes 730 matches the quality value 750. This process can take into consideration what the memory constraints of the miner are, causing the evaluation 770 to succeed with a greater frequency for larger memory configurations than for smaller memory configurations. This can simultaneously level the playing field to make the likelihood of the evaluation 770 succeeding roughly proportional to the size of the memory used to store the nodes used by the miner. In accordance with some embodiments, non-proportional relationships may be created by modifying the function used to compute the quality value 750. When the evaluation 770 results in success, then the output value 780 may be used to confirm the suitability of the memory configuration and validate the corresponding transaction.

In accordance with many embodiments, nodes 730 and 735 can also correspond to public keys. The miner may submit valid ledger entries, corresponding to a challenge-response pair including one of these nodes. In that case, public key values can become associated with the obtained NFT. As such, miners can use a corresponding secret/private key to sign transaction requests, such as purchases. Additionally, any type of digital signature can be used in this context, such as RSA signatures, Merkle signatures, DSS signatures, etc. Further, the nodes 730 and 735 may correspond to different public keys or to the same public key, the latter preferably augmented with a counter and/or other location indicator such as a matrix position indicator, as described above. Location indicators in accordance with many embodiments of the invention may be applied to point to locations within a given ledger. In accordance with some embodiments of the invention, numerous Proof of Space consensus configurations are possible, some of which are discussed below.

Hybrid methods of evaluating Proof of Space problems can also be implemented in accordance with many embodiments of the invention. In accordance with many embodiments, hybrid methods can be utilized that conceptually correspond to modifications of Proof of Space protocols in which extra effort is expanded to increase the probability of success, or to compress the amount of space that may be applied to the challenge. Both come at a cost of computational effort, thereby allowing miners to improve their odds of winning by spending greater computational effort. Accordingly, In accordance with many embodiments of the invention dual proof-based systems may be used to reduce said computational effort. Such systems may be applied to Proof of Work and Proof of Space schemes, as well as to any other type of mining-based scheme.

When utilizing dual proofs in accordance with various embodiments of the invention, the constituent proofs may have varying structures. For example, one may be based on Proof of Work, another on Proof of Space, and a third may be a system that relies on a trusted organization for controlling the operation, as opposed to relying on mining for the closing of ledgers. Yet other proof structures can be combined in this way. The result of the combination will inherit properties of its components. In accordance with many embodiments, the hybrid mechanism may incorporate a first and a second consensus mechanism. In accordance with several embodiments, the hybrid mechanism includes a first, a second, and a third consensus mechanisms. In a number of embodiments, the hybrid mechanism includes more than three consensus mechanisms. Any of these embodiments can utilize consensus mechanisms selected from the group including (but not limited to) Proof of Work, Proof of Space, and Proof of Stake without departing from the scope of the invention. Depending on how each component system is parametrized, different aspects of the inherited properties will dominate over other aspects.

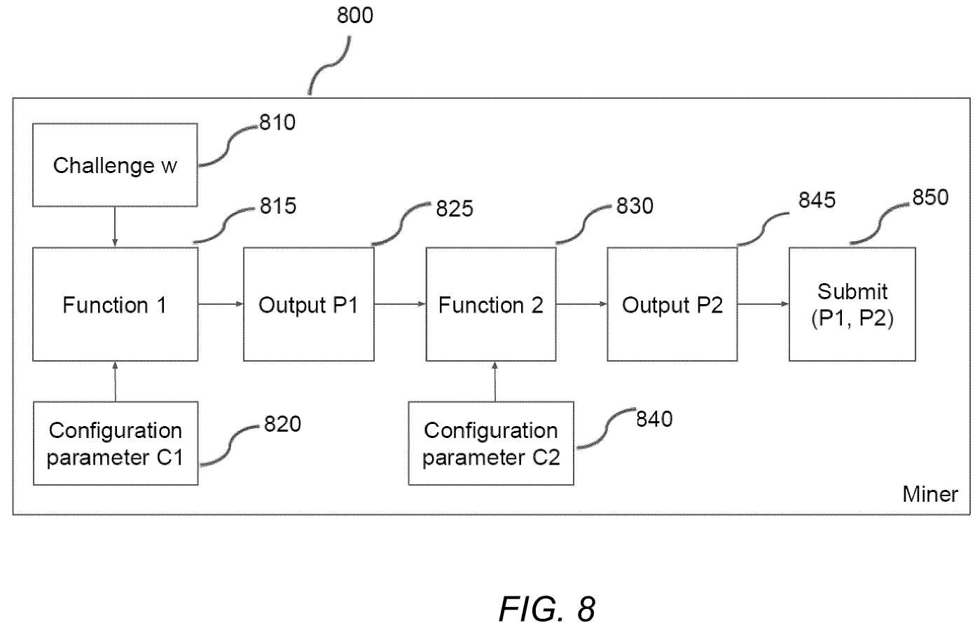

Dual proof configurations in accordance with a number of embodiments of the invention is illustrated in FIG. 8. A proof configuration in accordance with some embodiments of the invention may tend to use the notion of quality functions for tie-breaking among multiple competing correct proofs relative to a given challenge (w) 810. This classification of proof can be described as a qualitative proof, inclusive of proofs of work and proofs of space. In the example reflected in FIG. 8, proofs P1 and P2 are each one of a Proof of Work, Proof of Space, Proof of Stake, and/or any other proof related to a constrained resource, wherein P2 may be of a different type than P1, or may be of the same type.

Systems in accordance with many embodiments of the invention may introduce the notion of a qualifying proof, which, unlike qualitative proofs, are either valid or not valid, using no tie-breaking mechanism. Said systems may include a combination of one or more qualitative proofs and one or more qualifying proofs. For example, it may use one qualitative proof that is combined with one qualifying proof, where the qualifying proof is performed conditional on the successful creation of a qualitative proof. FIG. 8 illustrates challenge w 810, as described above, with a function 1 815, which is a qualitative function, and function 2 830, which is a qualifying function.

To stop miners from expending effort after a certain amount of effort has been spent, thereby reducing the environmental impact of mining, systems in accordance with a number of embodiments of the invention can constrain the search space for the mining effort. This can be done using a configuration parameter that controls the range of random or pseudo-random numbers that can be used in a proof. Upon challenge w 810 being issued to one or more miners 800, it can be input to Function 1 815 along with configuration parameter C1 820. Function 1815 may output proof P1 825, in this example the qualifying proof to Function 2 830. Function 2 830 is also provided with configuration parameter C2 840 and computes qualifying proof P2 845. The miner 800 can then submit the combination of proofs (P1, P2) 850 to a verifier, in order to validate a ledger associated with challenge w 810. In accordance with some embodiments, miner 800 can also submit the proofs (P1, P2) 850 to be accessed by a 3rd-party verifier.

NFT platforms in accordance with many embodiments of the invention may additionally benefit from alternative energy-efficient consensus mechanisms. Therefore, computer systems in accordance with several embodiments of the invention may instead use consensus-based methods alongside or in place of proof-of-space and proof-of-space based mining. In particular, consensus mechanisms based instead on the existence of a Trusted Execution Environment (TEE), such as ARM TrustZone(™) or Intel SGX(™) may provide assurances exist of integrity by virtue of incorporating private/isolated processing environments.

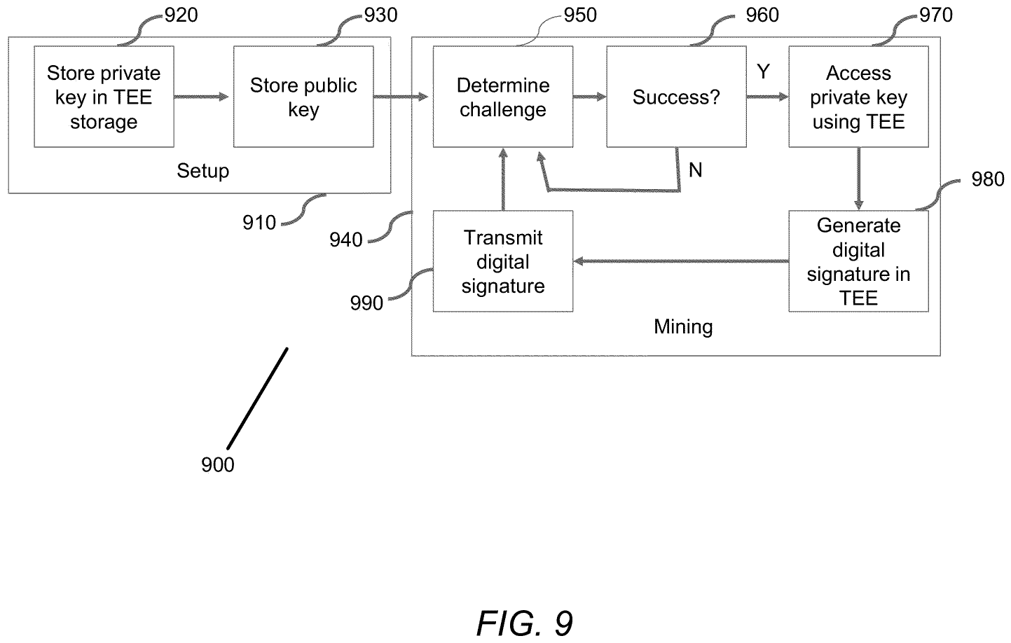

An illustration of sample process 900 undergone by TEE-based consensus mechanisms in accordance with some embodiments of the invention is depicted in FIG. 9. In accordance with some such configurations, a setup 910 may be performed by an original equipment manufacturer (OEM) or a party performing configurations of equipment provided by an OEM. Once a private key / public key pair is generated in the secure environment, process 900 may store (920) the private key in TEE storage (i.e. storage associated with the Trusted Execution Environment). While storage may be accessible from the TEE, it can be shielded from applications running outside the TEE. Additionally, processes can store (930) the public key associated with the TEE in any storage associated with the device containing the TEE. Unlike the private key, the public key may also be accessible from applications outside the TEE. In a number of embodiments, the public key may also be certified. Certification may come from OEMs or trusted entities associated with the OEMs, wherein the certificate can be stored with the public key.

In accordance with many embodiments of the invention, mining-directed steps can also be influenced by the TEE. In the illustrated embodiment, the process 900 can determine (950) a challenge. For example, this may be by computing a hash of the contents of a ledger. In doing so, process 900 may also determine whether the challenge corresponds to success 960. In accordance with some embodiments of the invention, the determination of success may result from some pre-set portion of the challenge matching a pre-set portion of the public key, e.g. the last 20 bits of the two values matching. In accordance with several embodiments the success determination mechanism may be selected from any of a number of alternate approaches appropriate to the requirements of specific applications. The matching conditions may also be modified over time. For example, modification may result from an announcement from a trusted party or based on a determination of a number of participants having reached a threshold value.

When the challenge does not correspond to a success 960, process 900 can return to determine (950) a new challenge. In this context, process 900 can determine (950) a new challenge after the ledger contents have been updated and/or a time-based observation is performed. In accordance with several embodiments the determination of a new challenge may come from any of a number of approaches appropriate to the requirements of specific applications, including, but not limited to, the observation of as a second elapsing since the last challenge. If the challenge corresponds to a success 960, then the processing can continue on to access (970) the private key using the TEE.

When the private key is accessed, process can generate (980) a digital signature using the TEE. The digital signature may be on a message that includes the challenge and/or which otherwise references the ledger entry being closed. Process 900 can also transmit (980) the digital signature to other participants implementing the consensus mechanism. In cases where multiple digital signatures are received and found to be valid, a tie-breaking mechanism can be used to evaluate the consensus. For example, one possible tie-breaking mechanism may be to select the winner as the party with the digital signature that represents the smallest numerical value when interpreted as a number. In accordance with several embodiments the tie-breaking mechanism may be selected from any of a number of alternate tie-breaking mechanisms appropriate to the requirements of specific applications.

Applications and methods in accordance with various embodiments of the invention are not limited to use within NFT platforms. Accordingly, it should be appreciated that consensus mechanisms described herein can also be implemented outside the context of an NFT platform network architecture unrelated to the storage of fungible tokens and/or NFTs. Moreover, any of the consensus mechanisms described herein with reference to FIGS. 6 - 9 (including Proof of Work, Proof of Space, Proof of Stake, and/or hybrid mechanisms) can be utilized within any of the blockchains implemented within the NFT platforms described above with reference to FIG. 3 - 5B. Various systems and methods for implementing NFT platforms and applications in accordance with numerous embodiments of the invention are discussed further below.

### NFT Platform Constituent Devices and Applications

A variety of computer systems that can be utilized within NFT platforms and systems that utilize NFT blockchains in accordance with various embodiments of the invention are illustrated below. The computer systems in accordance with many embodiments of the invention may implement a processing system 1010, 1120, 1220 using one or more CPUs, GPUs, ASICs, FPGAs, and/or any of a variety of other devices and/or combinations of devices that are typically utilized to perform digital computations. As can readily be appreciated each of these computer systems can be implemented using one or more of any of a variety of classes of computing devices including (but not limited to) mobile phone handsets, tablet computers, laptop computers, personal computers, gaming consoles, televisions, set top boxes and/or other classes of computing device.

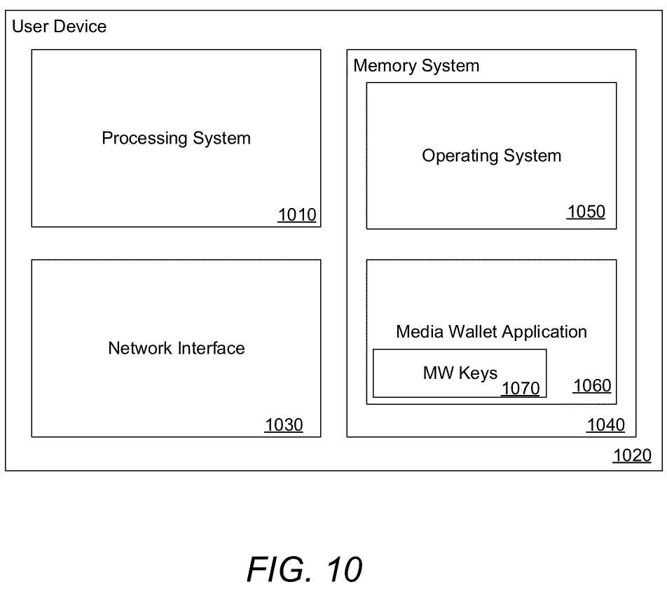

A user device capable of communicating with an NFT platform in accordance with an embodiment of the invention is illustrated in FIG. 10. The memory system 1040 of particular user devices may include an operating system 1050 and media wallet applications 1060. Media wallet applications may include sets of media wallet (MW) keys 1070 that can include public key/private key pairs. The set of MW keys may be used by the media wallet application to perform a variety of actions including, but not limited to, encrypting and signing data. In accordance with many embodiments, the media wallet application enables the user device to obtain and conduct transactions with respect to NFTs by communicating with an NFT blockchain via the network interface 1030. In accordance with some embodiments, the media wallet applications are capable of enabling the purchase of NFTs using fungible tokens via at least one distributed exchange. User devices may implement some or all of the various functions described above with reference to media wallet applications as appropriate to the requirements of a given application in accordance with various embodiments of the invention.

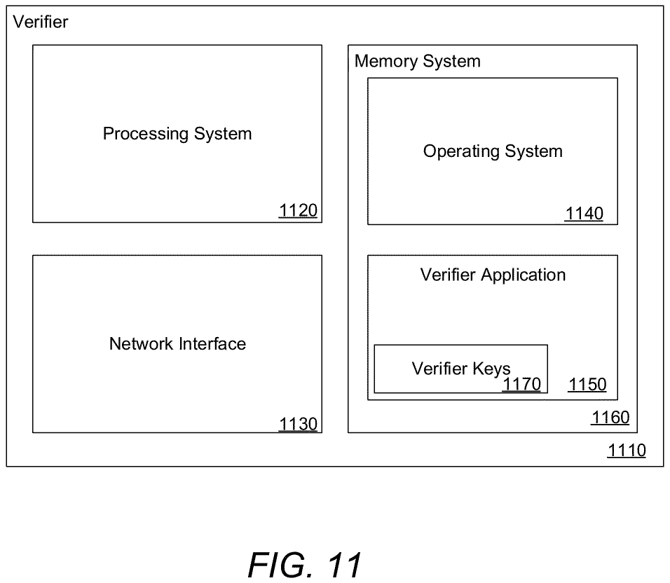

A verifier 1110 capable of verifying blockchain transactions in an NFT platform in accordance with many embodiments of the invention is illustrated in FIG. 11. The memory system 1160 of the verifier computer system includes an operating system 1140 and a verifier application 1150 that enables the verifier 1110 computer system to access a decentralized blockchain in accordance with various embodiments of the invention. Accordingly, the verifier application 1150 may utilize a set of verifier keys 1170 to affirm blockchain entries. When blockchain entries can be verified, the verifier application 1150 may transmit blocks to the corresponding blockchains. The verifier application 1150 can also implement some or all of the various functions described above with reference to verifiers as appropriate to the requirements of a given application in accordance with various embodiments of the invention.

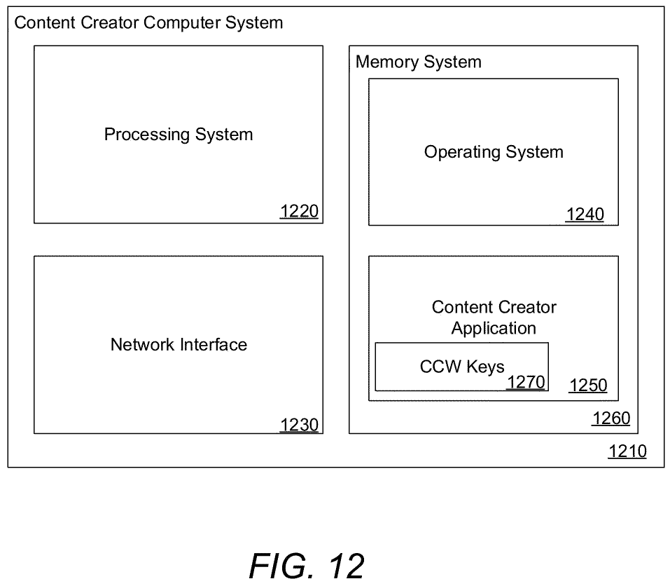

A content creator system 1210 capable of disseminating content in an NFT platform in accordance with an embodiment of the invention is illustrated in FIG. 12. The memory system 1260 of the content creator computer system may include an operating system 1240 and a content creator application 1250. The content creator application 1250 may enable the content creator computer system to mint NFTs by writing smart contracts to blockchains via the network interface 1230. The content creator application can include sets of content creator wallet (CCW) keys 1270 that can include a public key/private key pairs. Content creator applications may use these keys to sign NFTs minted by the content creator application. The content creator application can also implement some or all of the various functions described above with reference to content creators as appropriate to the requirements of a given application in accordance with various embodiments of the invention.

Computer systems in accordance with many embodiments of the invention incorporate digital wallets (herein also referred to as “wallets” or “media wallets”) for NFT and/or fungible token storage. In accordance with several embodiments, the digital wallet may securely store rich media NFTs and/or other tokens. Additionally, In accordance with some embodiments, the digital wallet may display user interface through which user instructions concerning data access permissions can be received.

In a number of embodiments of the invention, digital wallets may be used to store at least one type of token-directed content. Example content types may include, but are not limited to crypto currencies of one or more sorts; non-fungible tokens; and user profile data.

Example user profile data may incorporate logs of user actions. In accordance with some embodiments of the invention, example anonymized user profile data may include redacted, encrypted, and/or otherwise obfuscated user data. User profile data in accordance with some embodiments may include, but are not limited to, information related to classifications of interests, determinations of a post-advertisement purchases, and/or characterizations of wallet contents.

Media wallets, when storing content, may store direct references to content. Media wallets may also reference content through keys to decrypt and/or access the content. Media wallets may use such keys to additionally access metadata associated with the content. Example metadata may include, but is not limited to, classifications of content. In a number of embodiments, the classification metadata may govern access rights of other parties related to the content.

Access governance rights may include, but are not limited to, whether a party can indicate their relationship with the wallet; whether they can read summary data associated with the content; whether they have access to peruse the content; whether they can place bids to purchase the content; whether they can borrow the content, and/or whether they are biometrically authenticated.

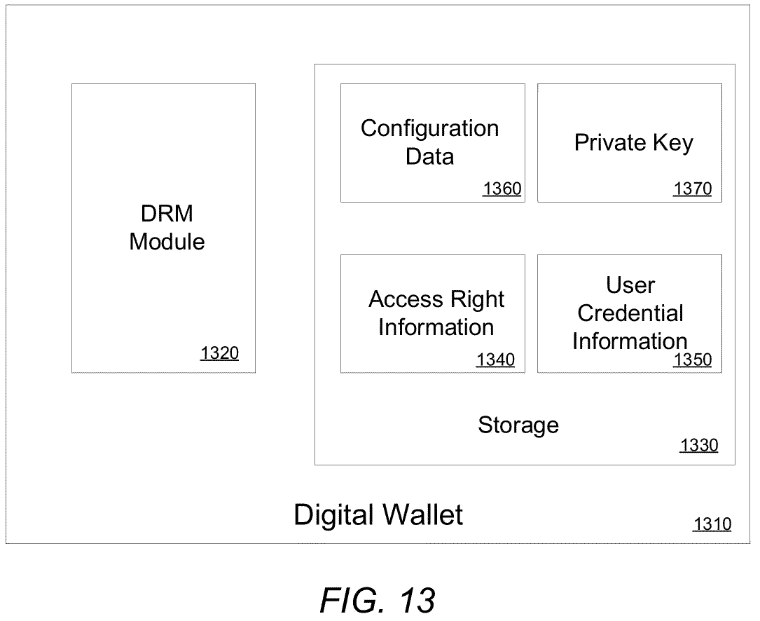

An example of a media wallet 1310 capable of storing rich media NFTs in accordance with an embodiment of the invention is illustrated in FIG. 13. Media wallets 1310 may include a storage component 1330, including access right information 1340, user credential information 1350, token configuration data 1360, and/or at least one private key 1370. In accordance with many embodiments of the invention, a private key 1370 may be used to perform a plurality of actions on resources, including (but not limited to) decrypting NFT and/or fungible token content. Media wallets may also correspond to a public key, referred to as a wallet address. An action performed by private keys 1370 may be used to prove access rights to digital rights management modules. Additionally, private keys 1370 may be applied to initiating ownership transfers and granting NFT and/or fungible token access to alternate wallets. In accordance with some embodiments, access right information 1340 may include lists of elements that the wallet 1310 has access to. Access right information 1340 may also express the type of access provided to the wallet. Sample types of access include, but are not limited to, the right to transfer NFT and/or fungible ownership, the right to play rich media associated with a given NFT, and the right to use an NFT and/or fungible token. Different rights may be governed by different cryptographic keys. Additionally, the access right information 1340 associated with a given wallet 1310 may utilize user credential information 1350 from the party providing access.

In accordance with many embodiments of the invention, third parties initiating actions corresponding to requesting access to a given NFT may require user credential information 1350 of the party providing access to be verified. User credential information 1350 may be taken from the group including, but not limited to, a digital signature, hashed passwords, PINs, and biometric credentials. User credential information 1350 may be stored in a manner accessible only to approved devices. In accordance with some embodiments of the invention, user credential information 1350 may be encrypted using a decryption key held by trusted hardware, such as a trusted execution environment. Upon verification, user credential information 1350 may be used to authenticate wallet access.

Available access rights may be determined by digital rights management (DRM) modules 1320 of wallets 1310. In the context of rich media, encryption may be used to secure content. As such, DRM systems may refer to technologies that control the distribution and use of keys required to decrypt and access content. DRM systems in accordance with many embodiments of the invention may require a trusted execution zone. Additionally, said systems may require one or more keys (typically a certificate containing a public key/private key pair) that can be used to communicate with and register with DRM servers. DRM modules 1320 In accordance with some embodiments may also use one or more keys to communicate with a DRM server. In accordance with several embodiments, the DRM modules 1320 may include code used for performing sensitive transactions for wallets including, but not limited to, content access. In accordance with a number of embodiments of the invention, the DRM module 1320 may execute in a Trusted Execution Environment. In a number of embodiments, the DRM may be facilitated by an Operating System (OS) that enables separation of processes and processing storage from other processes and their processing storage.

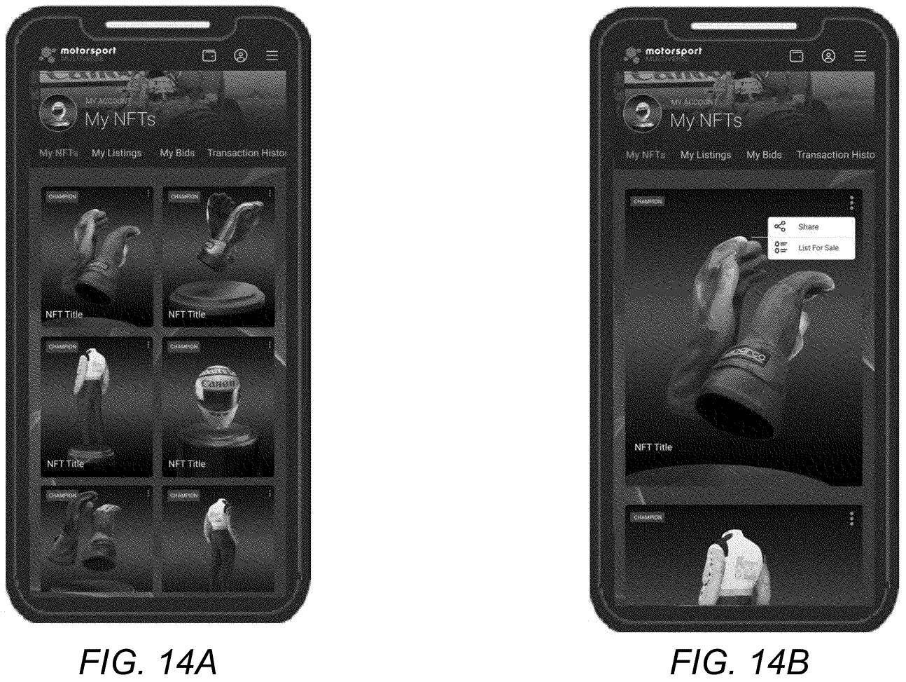

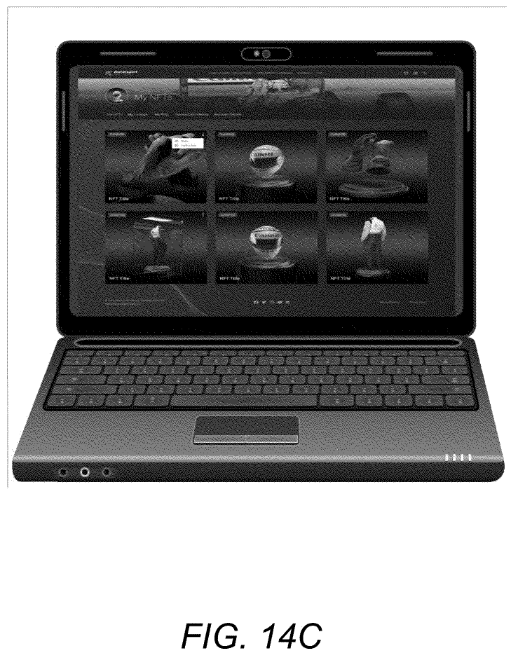

Operation of media wallet applications implemented in accordance with some embodiments of the invention is conceptually illustrated by way of the user interfaces shown in FIGS. 14A - 14C. In accordance with many embodiments, media wallet applications can refer to applications that are installed upon user devices such as (but not limited to) mobile phones and tablet computers running the iOS, Android and/or similar operating systems. Launching media wallet applications can provide a number of user interface contexts. In accordance with many embodiments, transitions between these user interface contexts can be initiated in response to gestures including (but not limited to) swipe gestures received via a touch user interface. As can readily be appreciated, the specific manner in which user interfaces operate through media wallet applications is largely dependent upon the user input capabilities of the underlying user device. In accordance with several embodiments, a first user interface context is a dashboard (see, FIGS. 14A, 14C) that can include a gallery view of NFTs owned by the user. In accordance with several embodiments, the NFT listings can be organized into category index cards. Category index cards may include, but are not limited to digital merchandise/collectibles, special event access/digital tickets, fan leaderboards. In certain embodiments, a second user interface context (see, for example, FIG. 14B) may display individual NFTs. In a number of embodiments, each NFT can be main-staged in said display with its status and relevant information shown. Users can swipe through each collectible and interacting with the user interface can launch a collectible user interface enabling greater interaction with a particular collectible in a manner that can be determined based upon the smart contract underlying the NFT.

A participant of an NFT platform may use a digital wallet to classify wallet content, including NFTs, fungible tokens, content that is not expressed as tokens such as content that has not yet been minted but for which the wallet can initiate minting, and other non-token content, including executable content, webpages, configuration data, history files and logs. This classification may be performed using a visual user interface. Users interface may enable users to create a visual partition of a space. In accordance with some embodiments of the invention, a visual partition may in turn be partitioned into sub-partitions. In accordance with some embodiments, a partition of content may separate wallet content into content that is not visible to the outside world (“invisible partition”), and content that is visible at least to some extent by the outside world (“visible partition”). Some of the wallet content may require the wallet use to have an access code such as a password or a biometric credential to access, view the existence of, or perform transactions on. A visible partition may be subdivided into two or more partitions, where the first one corresponds to content that can be seen by anybody, the second partition corresponds to content that can be seen by members of a first group, and/or the third partition corresponds to content that can be seen by members of a second group.

For example, the first group may be users with which the user has created a bond, and invited to be able to see content. The second group may be users who have a membership and/or ownership that may not be controlled by the user. An example membership may be users who own non-fungible tokens (NFTs) from a particular content creator. Content elements, through icons representing the elements, may be relocated into various partitions of the space representing the user wallet. By doing so, content elements may be associated with access rights governed by rules and policies of the given partition.

One additional type of visibility may be partial visibility. Partial visibility can correspond to a capability to access metadata associated with an item, such as an NFT and/or a quantity of crypto funds, but not carry the capacity to read the content, lend it out, or transfer ownership of it. As applied to a video NFT, an observer to a partition with partial visibility may not be able to render the video being encoded in the NFT but see a still image of it and a description indicating its source.

Similarly, a party may have access to a first anonymized profile which states that the user associated with the wallet is associated with a given demographic. The party with this access may also be able to determine that a second anonymized profile including additional data is available for purchase. This second anonymized profile may be kept in a sub-partition to which only people who pay a fee have access, thereby expressing a form of membership. Alternatively, only users that have agreed to share usage logs, aspects of usage logs or parts thereof may be allowed to access a given sub-partition. By agreeing to share usage log information with the wallet comprising the sub-partition, this wallet learns of the profiles of users accessing various forms of content, allowing the wallet to customize content, including by incorporating advertisements, and to determine what content to acquire to attract users of certain demographics.

Another type of membership may be held by advertisers who have sent promotional content to the user. These advertisers may be allowed to access a partition that stores advertisement data. Such advertisement data may be encoded in the form of anonymized profiles. In a number of embodiments, a given sub-partition may be accessible only to the advertiser to whom the advertisement data pertains. Elements describing advertisement data may be automatically placed in their associated partitions, after permission has been given by the user. This partition may either be visible to the user. Visibility may also depend on a direct request to see “system partitions.” A first partition may correspond to material associated with a first set of public keys, a second partition to material associated with a second set of public keys not overlapping with the first set of public keys, wherein such material may comprise tokens such as crypto coins and NFTs. A third partition may correspond to usage data associated with the wallet user, and a fourth partition may correspond to demographic data and/or preference data associated with the wallet user. Yet other partitions may correspond to classifications of content, e.g., child-friendly vs. adult; classifications of whether associated items are for sale or not, etc.

The placing of content in a given partition may be performed by a drag-and-drop action performed on a visual interface. By selecting items and clusters and performing a drag-and-drop to another partition and/or to a sub-partition, the visual interface may allow movement including, but not limited to, one item, a cluster of items, and a multiplicity of items and clusters of items. The selection of items can be performed using a lasso approach in which items and partitions are circled as they are displayed. The selection of items may also be performed by alternative methods for selecting multiple items in a visual interface, as will be appreciated by a person of skill in the art.

Some content classifications may be automated in part or full. For example, when user place ten artifacts, such as NFTs describing in-game capabilities, in a particular partition, they may be asked if additional content that are also in-game capabilities should be automatically placed in the same partition as they are acquired and associated with the wallet. When “yes” is selected, then this placement may be automated in the future. When “yes, but confirm for each NFT” is selected, then users can be asked, for each automatically classified element, to confirm its placement. Before the user confirms, the element may remain in a queue that corresponds to not being visible to the outside world. When users decline given classifications, they may be asked whether alternative classifications should be automatically performed for such elements onwards. In accordance with some embodiments, the selection of alternative classifications may be based on manual user classification taking place subsequent to the refusal.

Automatic classification of elements may be used to perform associations with partitions and/or folders. The automatic classification may be based on machine learning (ML) techniques considering characteristics including, but not limited to, usage behaviors exhibited by the user relative to the content to be classified, labels associated with the content, usage statistics; and/or manual user classifications of related content.

Multiple views of wallets may also be accessible. One such view can correspond to the classifications described above, which indicates the actions and interactions others can perform relative to elements. Another view may correspond to a classification of content based on use, type, and/or users-specified criterion. For example, all game NFTs may be displayed in one collection view. The collection view may further subdivide the game NFTs into associations with different games or collections of games. Another collection may show all audio content, clustered based on genre. users-specified classification may be whether the content is for purposes of personal use, investment, or both. A content element may show up in multiple views. users can search the contents of his or her wallet by using search terms that result in potential matches.

Alternatively, the collection of content can be navigated based the described views of particular wallets, allowing access to content. Once a content element has been located, the content may be interacted with. For example, located content elements may be rendered. One view may be switched to another after a specific item is found. For example, this may occur through locating an item based on its genre and after the item is found, switching to the partitioned view described above. In accordance with some embodiments, wallet content may be rendered using two or more views in a simultaneous manner. They may also select items using one view.

Media wallet applications in accordance with various embodiments of the invention are not limited to use within NFT platforms. Accordingly, it should be appreciated that applications described herein can also be implemented outside the context of an NFT platform network architecture unrelated to the storage of fungible tokens and/or NFTs. Moreover, any of the computer systems described herein with reference to FIG. 10-14C can be utilized within any of the NFT platforms described above.

### NFT Platform NFT Interactions

NFT platforms in accordance with many embodiments of the invention may incorporate a wide variety of rich media NFT configurations. The term “Rich Media Non-Fungible Tokens” can be used to refer to blockchain-based cryptographic tokens created with respect to a specific piece of rich media content and which incorporate programmatically defined digital rights management. In accordance with some embodiments of the invention, each NFT may have a unique serial number and be associated with a smart contract defining an interface that enables the NFT to be managed, owned and/or traded.

Under a rich media blockchain in accordance with many embodiments of the invention, a wide variety of NFT configurations may be implemented. Some NFTs may be referred to as anchored NFTs (or anchored tokens), used to tie some element, such as a physical entity, to an identifier. Of this classification, one sub-category may be used to tie users’ real-world identities and/or identifiers to a system identifier, such as a public key. In this disclosure, this type of NFT applied to identifying users, may be called a social NFT, identity NFT, identity token, and a social token. In accordance with many embodiments of the invention, an individual’s personally identifiable characteristics may be contained, maintained, and managed throughout their lifetime so as to connect new information and/or NFTs to the individual’s identity. A social NFT’s information may include, but are not limited to, personally identifiable characteristics such as name, place and date of birth, and/or biometrics.

An example social NFT may assign a DNA print to a newborn’s identity. In accordance with a number of embodiments of the invention, this first social NFT might then be used in the assignment process of a social security number NFT from the federal government. In accordance with some embodiments, the first social NFT may then be associated with some rights and capabilities, which may be expressed in other NFTs. Additional rights and capabilities may also be directly encoded in a policy of the social security number NFT.

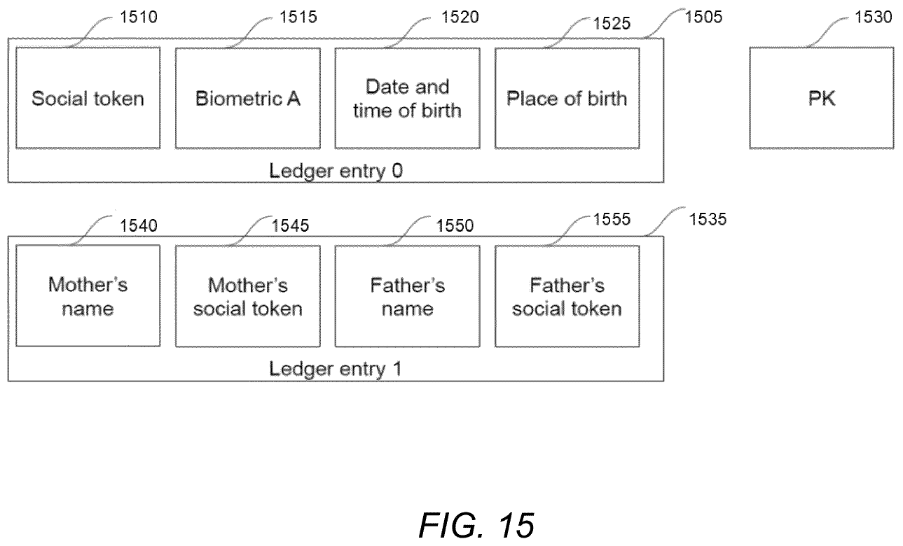

A social NFT may exist on a personalized branch of a centralized and/or decentralized blockchain. Ledger entries related to an individual’s social NFT in accordance with several embodiments of the invention are depicted in FIG. 15. Ledger entries of this type may be used to build an immutable identity foundation whereby biometrics, birth and parental information are associated with an NFT. As such, this information may also be protected with encryption using a private key 1530. The initial entry in a ledger, “ledger entry 0” 1505, may represent a social token 1510 assignment to an individual with a biometric “A” 1515. In this embodiment, the biometric may include but is not limited to a footprint, a DNA print, and a fingerprint. The greater record may also include the individual’s date and time of birth 1520 and place of birth 1525. A subsequent ledger entry 1 1535 may append parental information including (but not limited to) mothers’ name 1540, mother’s social token 1545, father’s name 1550, and father’s social token 1555.

In a number of embodiments, the various components that make up a social NFT may vary from situation to situation. In a number of embodiments, biometrics and/or parental information may be unavailable in a given situation and/or period of time. Other information including, but not limited to, race gender, and governmental number assignments such as social security numbers, may be desirable to include in the ledger. In a blockchain, future NFT creation may create a life-long ledger record of an individual’s public and private activities. In accordance with some embodiments, the record may be associated with information including, but not limited to, identity, purchases, health and medical records, access NFTs, family records such as future offspring, marriages, familial history, photographs, videos, tax filings, and/or patent filings. The management and/or maintenance of an individual’s biometrics throughout the individual’s life may be immutably connected to the first social NFT given the use of a decentralized blockchain ledger.

In accordance with some embodiments, a certifying third party may generate an NFT associated with certain rights upon the occurrence of a specific event. In one such embodiment, the DMV may be the certifying party and generate an NFT associated with the right to drive a car upon issuing a traditional driver’s license. In another embodiment, the certifying third party may be a bank that verifies a person’s identity papers and generates an NFT in response to a successful verification. In a third embodiment, the certifying party may be a car manufacturer, who generates an NFT and associates it with the purchase and/or lease of a car.

In accordance with many embodiments, a rule may specify what types of policies the certifying party may associate with the NFT. Additionally, a non-certified entity may also generate an NFT and assert its validity. This may require putting up some form of security. In one example, security may come in the form of a conditional payment associated with the NFT generated by the non-certified entity. In this case, the conditional payment may be exchangeable for funds if abuse can be detected by a bounty hunter and/or some alternate entity. Non-certified entities may also relate to a publicly accessible reputation record describing the non-certified entity’s reputability.

Anchored NFTs may additionally be applied to automatic enforcement of programming rules in resource transfers. NFTs of this type may be referred to as promise NFTs. A promise NFT may include an agreement expressed in a machine-readable form and/or in a human-accessible form. In a number of embodiments, the machine-readable and human-readable elements can be generated one from the other. In accordance with some embodiments, an agreement in a machine-readable form may include, but is not limited to, a policy and/or an executable script. In accordance with some embodiments, an agreement in a human-readable form may include, but is not limited to, a text and/or voice-based statement of the promise.

In accordance with some embodiments, regardless of whether the machine-readable and human-readable elements are generated from each other, one can be verified based on the other. Smart contracts including both machine-readable statements and human-accessible statements may also be used outside the implementation of promise NFTs. Moreover, promise NFTs may be used outside actions taken by individual NFTs and/or NFT-owners. In accordance with some embodiments, promise NFTs may relate to general conditions, and may be used as part of a marketplace.

In one such example, horse betting may be performed through generating a first promise NFT that offers a payment of $10 if a horse does not win. Payment may occur under the condition that the first promise NFT is matched with a second promise NFT that causes a transfer of funds to a public key specified with the first promise NFT if horse X wins.

A promise NFT may be associated with actions that cause the execution of a policy and/or rule indicated by the promise NFT. In accordance with some embodiments of the invention, a promise of paying a charity may be associated with the sharing of an NFT. In this embodiment, the associated promise NFT may identify a situation that satisfies the rule associated with the promise NFT, thereby causing the transfer of funds when the condition is satisfied (as described above). One method of implementation may be embedding in and/or associating a conditional payment with the promise NFT. A conditional payment NFT may induce a contract causing the transfer of funds by performing a match. In accordance with some such methods, the match may be between the promise NFT and inputs that identify that the conditions are satisfied, where said input can take the form of another NFT. In a number of embodiments, one or more NFTs may also relate to investment opportunities.

For example, a first NFT may represent a deed to a first building, and a second NFT a deed to a second building. Moreover, the deed represented by the first NFT may indicate that a first party owns the first property. The deed represented by the second NFT may indicate that a second party owns the second property. A third NFT may represent one or more valuations of the first building. The third NFT may in turn be associated with a fourth NFT that may represent credentials of a party performing such a valuation. A fifth NFT may represent one or more valuations of the second building. A sixth may represent the credentials of one of the parties performing a valuation. The fourth and sixth NFTs may be associated with one or more insurance policies, asserting that if the parties performing the valuation are mistaken beyond a specified error tolerance, then the insurer would pay up to a specified amount.

A seventh NFT may then represent a contract that relates to the planned acquisition of the second building by the first party, from the second party, at a specified price. The seventh NFT may make the contract conditional provided a sufficient investment and/or verification by a third party. A third party may evaluate the contract of the seventh NFT, and determine whether the terms are reasonable. After the evaluation, the third party may then verify the other NFTs to ensure that the terms stated in the contract of the seventh NFT agree. If the third party determines that the contract exceeds a threshold in terms of value to risk, as assessed in the seventh NFT, then executable elements of the seventh NFT may cause transfers of funds to an escrow party specified in the contract of the sixth NFT.

Alternatively, the first party may initiate the commitment of funds, conditional on the remaining funds being raised within a specified time interval. The commitment of funds may occur through posting the commitment to a ledger. Committing funds may produce smart contracts that are conditional on other events, namely the payments needed to complete the real estate transaction. The smart contract also may have one or more additional conditions associated with it. For example, an additional condition may be the reversal of the payment if, after a specified amount of time, the other funds have not been raised. Another condition may be related to the satisfactory completion of an inspection and/or additional valuation.

NFTs may also be used to assert ownership of virtual property. Virtual property in this instance may include, but is not limited to, rights associated with an NFT, rights associated with patents, and rights associated with pending patents. In a number of embodiments, the entities involved in property ownership may be engaged in fractional ownership. In accordance with some such embodiments, two parties may wish to purchase an expensive work of digital artwork represented by an NFT. The parties can enter into smart contracts to fund and purchase valuable works. After a purchase, an additional NFT may represent each party’s contribution to the purchase and equivalent fractional share of ownership.

Another type of NFTs that may relate to anchored NFTs may be called “relative NFTs.” This may refer to NFTs that relate two or more NFTs to each other. Relative NFTs associated with social NFTs may include digital signatures that is verified using a public key of a specific social NFT. In accordance with some embodiments, an example of a relative NFT may be an assertion of presence in a specific location, by a person corresponding to the social NFT. This type of relative NFT may also be referred to as a location NFT and a presence NFT. Conversely, a signature verified using a public key embedded in a location NFT may be used as proof that an entity sensed by the location NFT is present. Relative NFTs are derived from other NFTs, namely those they relate to, and therefore may also be referred to as derived NFTs. Anchored NFT may tie to another NFT, which may make it both anchored and relative. An example of such may be called pseudonym NFTs.

Pseudonym NFTs may be a kind of relative NFT acting as a pseudonym identifier associated with a given social NFT. In accordance with some embodiments, pseudonym NFTs may, after a limited time and/or a limited number of transactions, be replaced by a newly derived NFTs expressing new pseudonym identifiers. This may disassociate users from a series of recorded events, each one of which may be associated with different pseudonym identifiers. A pseudonym NFT may include an identifier that is accessible to biometric verification NFTs. Biometric verification NFTs may be associated with a TEE and/or DRM which is associated with one or more biometric sensors. Pseudonym NFTs may be output by social NFTs and/or pseudonym NFTs.

Inheritance NFTs may be another form of relative NFTs, that transfers rights associated with a first NFT to a second NFT. For example, computers, represented by anchored NFT that is related to a physical entity (the hardware), may have access rights to WiFi networks. When computers are replaced with newer models, users may want to maintain all old relationships, for the new computer. For example, users may want to retain WiFi hotspots. For this to be facilitated, a new computer can be represented by an inheritance NFT, inheriting rights from the anchored NFT related to the old computer. An inheritance NFT may acquire some or all pre-existing rights associated with the NFT of the old computer, and associate those with the NFT associated with the new computer.

More generally, multiple inheritance NFTs can be used to selectively transfer rights associated with one NFT to one or more NFTs, where such NFTs may correspond to users, devices, and/or other entities, when such assignments of rights are applicable. Inheritance NFTs can also be used to transfer property. One way to implement the transfer of property can be to create digital signatures using private keys. These private keys may be associated with NFTs associated with the rights. In accordance with a number of embodiments, transfer information may include the assignment of included rights, under what conditions the transfer may happen, and to what NFT(s) the transfer may happen. In this transfer, the assigned NFTs may be represented by identifies unique to these, such as public keys. The digital signature and message may then be in the form of an inheritance NFT, or part of an inheritance NFT. As rights are assigned, they may be transferred away from previous owners to new owners through respective NFTs. Access to financial resources is one such example.

However, sometimes rights may be assigned to new parties without taking the same rights away from the party (i.e., NFT) from which the rights come. One example of this may be the right to listen to a song, when a license to the song is sold by the artist to consumers. However, if the seller sells exclusive rights, this causes the seller not to have the rights anymore.

In accordance with many embodiments of the invention, multiple alternative NFT configurations may be implemented. One classification of NFT may be an employee NFT or employee token. Employee NFTs may be used by entities including, but not limited to, business employees, students, and organization members. Employee NFTs may operate in a manner analogous to key card photo identifications. In a number of embodiments, employee NFTs may reference information including, but not limited to, company information, employee identity information and/or individual identity NFTs.

Additionally, employee NFTs may include associated access NFT information including (but not limited to) what portions of a building employees may access, and what computer system employees may utilize. In accordance with several embodiments, employee NFTs may incorporate their owner’s biometrics, such as a face image. In a number of embodiments, employee NFTs may operate as a form of promise NFT. In accordance with some embodiments, employee NFT may comprise policies or rules of employing organization. In a number of embodiments, the employee NFT may reference a collection of other NFTs.

Another type of NFT may be referred to as the promotional NFT or promotional token. Promotional NFTs may be used to provide verification that promoters provide promotion winners with promised goods. In accordance with some embodiments, promotional NFTs may operate through decentralized applications for which access restricted to those using an identity NFT. The use of a smart contract with a promotional NFT may be used to allow for a verifiable release of winnings. These winnings may include, but are not limited to, cryptocurrency, money, and gift card NFTs useful to purchase specified goods. Smart contracts used alongside promotional NFTs may be constructed for winners selected through random number generation.

Another type of NFT may be called the script NFT or script token. Script tokens may incorporate script elements including, but not limited to, story scripts, plotlines, scene details, image elements, avatar models, sound profiles, and voice data for avatars. Script tokens may also utilize rules and policies that describe how script elements are combined. Script tokens may also include rightsholder information, including (but not limited to), licensing and copyright information. Executable elements of script tokens may include instructions for how to process inputs; how to configure other elements associated with the script tokens; and how to process information from other tokens used in combination with script tokens.

Script tokens may be applied to generate presentations of information. In accordance with some embodiments, these presentations may be developed on devices including (but not limited to) traditional computers, mobile computers, and virtual reality display devices. Script tokens may be used to provide the content for game avatars, digital assistant avatars, and/or instructor avatars. Script tokens may comprise audio-visual information describing how input text is presented, along with the input text that provides the material to be presented. It may also comprise what may be thought of as the personality of the avatar, including how the avatar may react to various types of input from an associated user.

In accordance with some embodiments, script NFTs may be applied to govern behavior within an organization. For example, this may be done through digital signatures asserting the provenance of the scripts. Script NFTs may also, in full and/or in part, be generated by freelancers. For example, a text script related to a movie, an interactive experience, a tutorial, and/or other material, may be created by an individual content creator. This information may then be combined with a voice model or avatar model created by an established content producer. The information may then be combined with a background created by additional parties. Various content producers can generate parts of the content, allowing for large-scale content collaboration.

Features of other NFTs can be incorporated in a new NFT using techniques related to inheritance NFTs, and/or by making references to other NFTs. As script NFTs may consist of multiple elements, creators with special skills related to one particular element may generate and combine elements. This may be used to democratize not only the writing of storylines for content, but also outsourcing for content production. For each such element, an identifier establishing the origin or provenance of the element may be included. Policy elements can also be incorporated that identify the conditions under which a given script element may be used. Conditions may be related to, but are not limited to execution environments, trusts, licenses, logging, financial terms for use, and various requirements for the script NFTs. Requirements may concern, but are not limited to, what other types of elements the given element are compatible with, what is allowed to be combined with according the terms of service, and/or local copyright laws that must be obeyed.

Evaluation units may be used with various NFT classifications to collect information on their use. Evaluation units may take a graph representing subsets of existing NFTs and make inferences from the observed graph component. From this, valuable insights into NFT value may be derived. For example, evaluation units may be used to identify NFTs whose popularity is increasing or waning. In that context, popularity may be expressed as, but not limited to, the number of derivations of the NFT that are made; the number of renderings, executions or other uses are made; and the total revenue that is generated to one or more parties based on renderings, executions or other uses.

Evaluation units may make their determination through specific windows of time and/or specific collections of end-users associated with the consumption of NFT data in the NFTs. Evaluation units may limit assessments to specific NFTs (e.g. script NFTs). This may be applied to identify NFTs that are likely to be of interest to various users. In addition, the system may use rule-based approaches to identify NFTs of importance, wherein importance may be ascribed to, but is not limited to, the origination of the NFTs, the use of the NFTs, the velocity of content creation of identified clusters or classes, the actions taken by consumers of NFT, including reuse of NFTs, the lack of reuse of NFTs, and the increased or decreased use of NFTs in selected social networks.

Evaluations may be repurposed through recommendation mechanisms for individual content consumers and/or as content originators. Another example may address the identification of potential combination opportunities, by allowing ranking based on compatibility. Accordingly, content creators such as artists, musicians and programmers can identify how to make their content more desirable to intended target groups.

The generation of evaluations can be supported by methods including, but not limited to machine learning (ML) methods, artificial intelligence (Al) methods, and/or statistical methods. Anomaly detection methods developed to identify fraud can be repurposed to identify outliers. This can be done to flag abuse risks or to improve the evaluation effort.

Multiple competing evaluation units can make competing predictions using alternative and proprietary algorithms. Thus, different evaluation units may be created to identify different types of events to different types of subscribers, monetizing their insights related to the data they access.

In a number of embodiments, evaluation units may be a form of NFTs that derive insights from massive amounts of input data. Input data may correspond, but is not limited to the graph component being analyzed. Such NFTs may be referred to as evaluation unit NFTs.

The minting of NFTs may associate rights with first owners and/or with an optional one or more policies and protection modes. An example policy and/or protection mode directed to financial information may express royalty requirements. An example policy and/or protection mode directed to non-financial requirements may express restrictions on access and/or reproduction. An example policy directed to data collection may express listings of user information that may be collected and disseminated to other participants of the NFT platform.

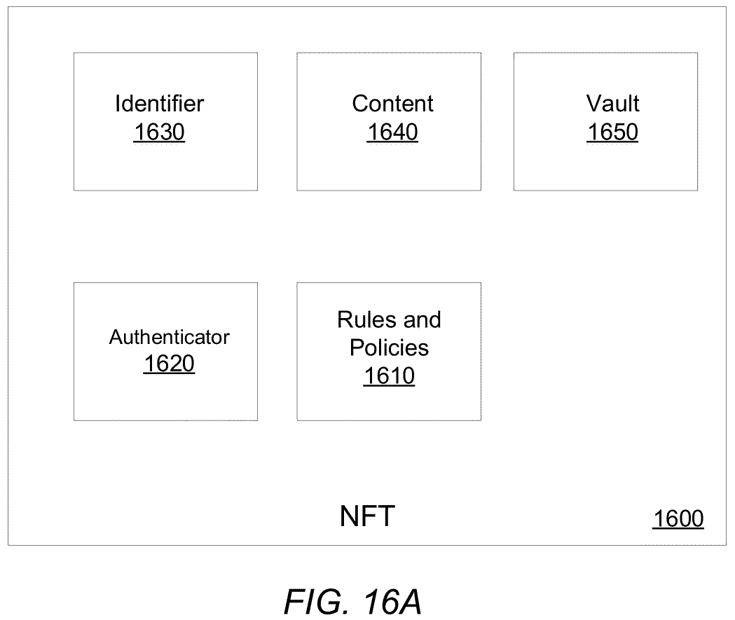

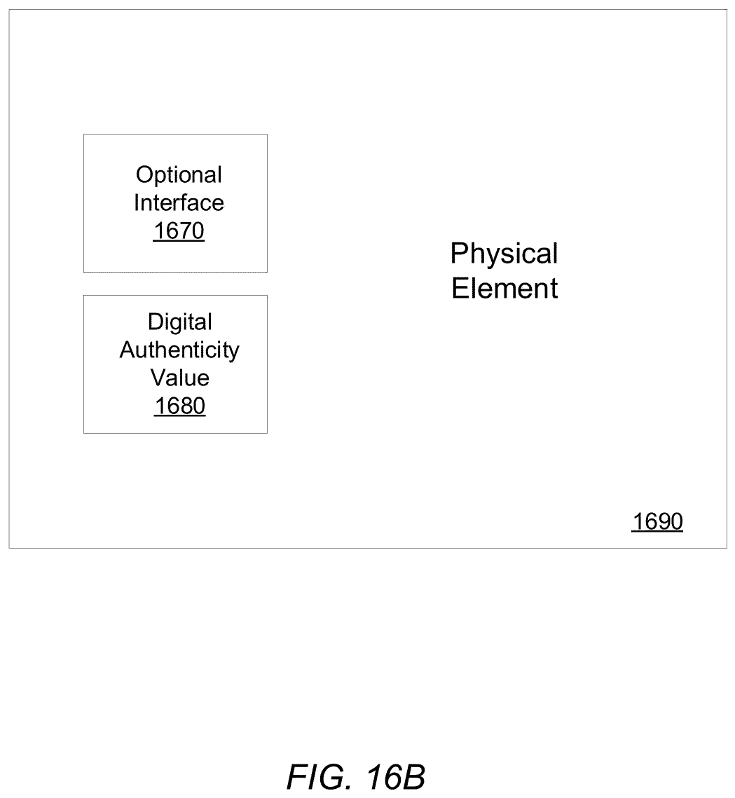

An example NFT which may be associated with specific content in accordance with several embodiments of the invention is illustrated in FIG. 16A. In accordance with some embodiments, an NFT 1600 may utilize a vault 1650, which may control access to external data storage areas. Methods of controlling access may include, but are not limited to, user credential information 1350. In accordance with a number of embodiments of the invention, control access may be managed through encrypting content 1640. As such, NFTs 1600 can incorporate content 1640, which may be encrypted, not encrypted, yet otherwise accessible, or encrypted in part. In accordance with some embodiments, an NFT 1600 may be associated with one or more content 1640 elements, which may be contained in or referenced by the NFT. A content 1640 element may include, but is not limited to, an image, an audio file, a script, a biometric user identifier, and/or data derived from an alternative source. An example alternative source may be a hash of biometric information). An NFT 1600 may also include an authenticator 1620 capable of affirming that specific NFTs are valid.

In accordance with many embodiments of the invention, NFTs may include a number of rules and policies 1610. Rules and policies 1610 may include, but are not limited to access rights information 1340. In accordance with some embodiments, rules and policies 1610 may also state terms of usage, royalty requirements, and/or transfer restrictions. An NFT 1600 may also include an identifier 1630 to affirm ownership status. In accordance with many embodiments of the invention, ownership status may be expressed by linking the identifier 1630 to an address associated with a blockchain entry.

In accordance with a number of embodiments of the invention, NFTs may represent static creative content. NFTs may also be representative of dynamic creative content, which changes over time. In accordance with many examples of the invention, the content associated with an NFT may be a digital content element.

One example of a digital content element in accordance with some embodiments may be a set of five images of a mouse. In this example, the first image may be an image of the mouse being alive. The second may be an image of the mouse eating poison. The third may be an image of the mouse not feeling well. The fourth image may be of the mouse, dead. The fifth image may be of a decaying mouse.

The user credential information 1350 of an NFT may associate each image to an identity, such as of the artist. In accordance with a number of embodiments of the invention, NFT digital content can correspond to transitions from one representation (e.g., an image of the mouse, being alive) to another representation (e.g., of the mouse eating poison). In this disclosure, digital content transitioning from one representation to another may be referred to as a state change and/or an evolution. In a number of embodiments, an evolution may be triggered by the artist, by an event associated with the owner of the artwork, randomly, and/or by an external event.

When NFTs representing digital content are acquired in accordance with some embodiments of the invention, they may also be associated with the transfer of corresponding physical artwork, and/or the rights to said artwork. The first ownership records for NFTs may correspond to when the NFT was minted, at which time its ownership can be assigned to the content creator. Additionally, in the case of “lazy” minting, rights may be directly assigned to a buyer.

In accordance with some embodiments, as a piece of digital content evolves, it may also change its representation. The change in NFTs may also send a signal to an owner after it has evolved. In doing so, a signal may indicate that the owner has the right to acquire the physical content corresponding to the new state of the digital content. Under an earlier example, buying a live mouse artwork, as an NFT, may also carry the corresponding painting, and/or the rights to it. A physical embodiment of an artwork that corresponds to that same NFT may also be able to replace the physical artwork when the digital content of the NFT evolves. For example, should the live mouse artwork NFT change states to a decaying mouse, an exchange may be performed of the corresponding painting for a painting of a decaying mouse.

The validity of one of the elements, such as the physical element, can be governed by conditions related to an item with which it is associated. For example, a physical painting may have a digital authenticity value that attests to the identity of the content creator associated with the physical painting.

An example of a physical element 1690 corresponding to an NFT, in accordance with some embodiments of the invention is illustrated in FIG. 16B. A physical element 1690 may be a physical artwork including, but not limited to, a drawing, a statue, and/or another physical representation of art. In a number of embodiments, physical representations of the content (which may correspond to a series of paintings) may each be embedded with a digital authenticity value (or a validator value) value. In accordance with many embodiments of the invention, a digital authenticity value (DAV) 1680 may be therefore be associated with a physical element 1690 and a digital element. A digital authenticity value may be a value that includes an identifier and a digital signature on the identifier. In accordance with some embodiments the identifier may specify information related to the creation of the content. This information may include the name of the artist, the identifier 1630 of the digital element corresponding to the physical content, a serial number, information such as when it was created, and/or a reference to a database in which sales data for the content is maintained. A digital signature element affirming the physical element may be made by the content creator and/or by an authority associating the content with the content creator.

In accordance with some embodiments, the digital authenticity value 1680 of the physical element 1690 can be expressed using a visible representation. The visible representation may be an optional physical interface 1670 taken from a group including, but not limited to, a barcode and a quick response (QR) code encoding the digital authenticity value. In accordance with some embodiments, the encoded value may also be represented in an authenticity database. Moreover, the physical interface 1670 may be physically associated with the physical element. One example of such may be a OR tag being glued to or printed on the back of a canvas. In accordance with some embodiments of the invention, the physical interface 1670 may be possible to physically disassociate from the physical item it is attached to. However, if a DAV 1680 is used to express authenticity of two or more physical items, the authenticity database may detect and block a new entry during the registration of the second of the two physical items. For example, if a very believable forgery is made of a painting the forged painting may not be considered authentic without the OR code associated with the digital element.

In a number of embodiments, the verification of the validity of a physical item, such as a piece of artwork, may be determined by scanning the DAV. In accordance with some embodiments, scanning the DAV may be used to determine whether ownership has already been assigned. Using techniques like this, each physical item can be associated with a control that prevents forgeries to be registered as legitimate, and therefore, makes them not valid. In the context of a content creator receiving a physical element from an owner, the content creator can deregister the physical element 1690 by causing its representation to be erased from the authenticity database used to track ownership. Alternatively, in the case of an immutable blockchain record, the ownership blockchain may be appended with new information. Additionally, in instances where the owner returns a physical element, such as a painting, to a content creator in order for the content creator to replace it with an “evolved” version, the owner may be required to transfer the ownership of the initial physical element to the content creator, and/or place the physical element in a stage of being evolved.

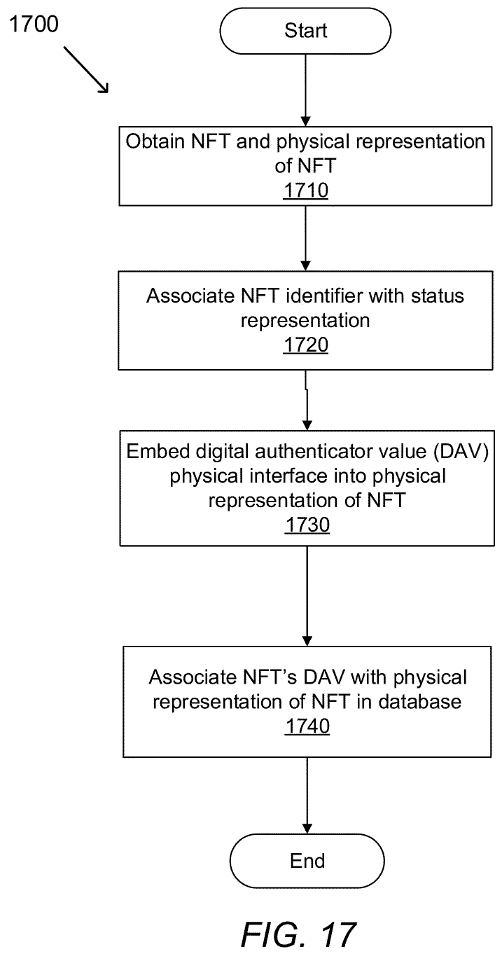

An example of a process for connecting an NFT digital element to physical content in accordance with some embodiments of the invention is illustrated in FIG. 17. Process 1700 may obtain (1710) an NFT and a physical representation of the NFT in connection with an NFT transaction. Under the earlier example, this may be a painting of a living mouse and an NFT of a living mouse. By virtue of establishing ownership of the NFT, the process 1700 may associate (1720) an NFT identifier with a status representation of the NFT. The NFT identifier may specify attributes including, but not limited to, the creator of the mouse painting and NFT (“Artist”), the blockchain the NFT is on (“NFT-Chain”), and an identifying value for the digital element (“no. 0001”). Meanwhile, the status representation may clarify the present state of the NFT (“alive mouse”). Process 1700 may also embed (1730) a DAV physical interface into the physical representation of the NFT. In a number of embodiments of the invention, this may be done by implanting a OR code into the back of the mouse painting. In affirming the connection between the NFT and painting, Process 1700 can associate (1740) the NFT’s DAV with the physical representation of the NFT in a database. In accordance with some embodiments, the association can be performed through making note of the transaction and clarifying that it encapsulates both the mouse painting and the mouse NFT.

While specific processes are described above with reference to FIGS. 15-17, NFTs can be implemented in any of a number of different ways to enable as appropriate to the requirements of specific applications in accordance with various embodiments of the invention. Additionally, the specific manner in which NFTs can be utilized within NFT platforms in accordance with various embodiments of the invention is largely dependent upon the requirements of a given application.

### Transaction-Directed Functionality on NFT Platforms

NFT platforms in accordance with many embodiments of the invention may implement systems directed to various transaction-based capabilities. Transaction-enabling functionality can be applied to protecting tokens, obtaining royalties for content, and protecting against fraudulent activity.

Methods operating in accordance with some embodiments of the invention may include content locking methods applicable to one or more containers associated with individual tokens. Locking methods may be applied to enable users to engage in the sale, rental, and/or loaning of tokens. For example, a first container may hold descriptions of the content included in other containers, including but not limited to trial versions, movies, screenshots, textual descriptions, and/or references to any of these items. A second container may hold executable content, configuration data that may encode character personalities in games, digital assets used in a game, unlock keys used to enable select functionalities of software associated with the token, etc. A third container may hold game-based content: artwork to be used in a game; extensions, plugins, and references for the game; representations of value in the game, etc. Any or all containers associated with sets of tokens may be locked, limiting access to the data stored within.

Utilizing the content locking methods, containers may be locked and unlocked, enabling compatible readers to access information in the containers. Containers being locked may limit access rights associated with the containers and/or the corresponding token(s), including but not limited to transfer capabilities associated with the token(s) and access to the information in the containers by users. In accordance with some embodiments, locked containers may require actions by specified intermediaries to be used and/or unlocked by receiving parties. Locked content portions may be associated with lock values, where lock values can be used to unlock locked content portions. Lock values may be sent in response to identifying completed transactions. Lock values may include, but are not limited to, decryption keys and/or digital rights management (DRM) capabilities, like digitally-signed access values.

Additionally or alternatively, systems configured in accordance with some embodiments of the invention may implement anchors to govern various rights, including but not limited to the importation of tokens into application environments. Anchors may operate as key values embedded in software units and be used to access tokens and/or containers. In accordance with certain embodiments, anchors may have matching identifiers (e.g., an identifier of X intermediary) and/or matching representations of lock values. For example, individual applications configured in accordance with numerous embodiments of the invention may be enabled to import tokens (to be used on the application) when anchors match at least one of the identifiers associated with the tokens. Additionally or alternatively, locks associated with locked content portions of certain tokens may, upon matching with an anchor, be unlocked and allow access to the content portions. Different versions of applications may correspond to different anchor values. Different downloads of individual applications may correspond to different anchor values. In accordance with a number of embodiments, tokens, including but not limited to NFTs, can be imported to application environments according to matches to anchors.

Anchors may include but are not limited to digitally-signed values. In such cases, the digital signature may be generated by, enabled in full, and/or enabled in part by entities representing the application provider(s). The verification of anchors, in such situations, may be performed using the public key of the signer. The value(s) that are digitally-signed may be, but are not limited to, the identifier(s) of the intermediaries, portion(s) of such values, and/or derived from such values. The identifiers of the intermediaries, likewise, may include digital signatures on anchors. Such signatures may correspond to the marketplace and/or portions of data associated with the related anchor.

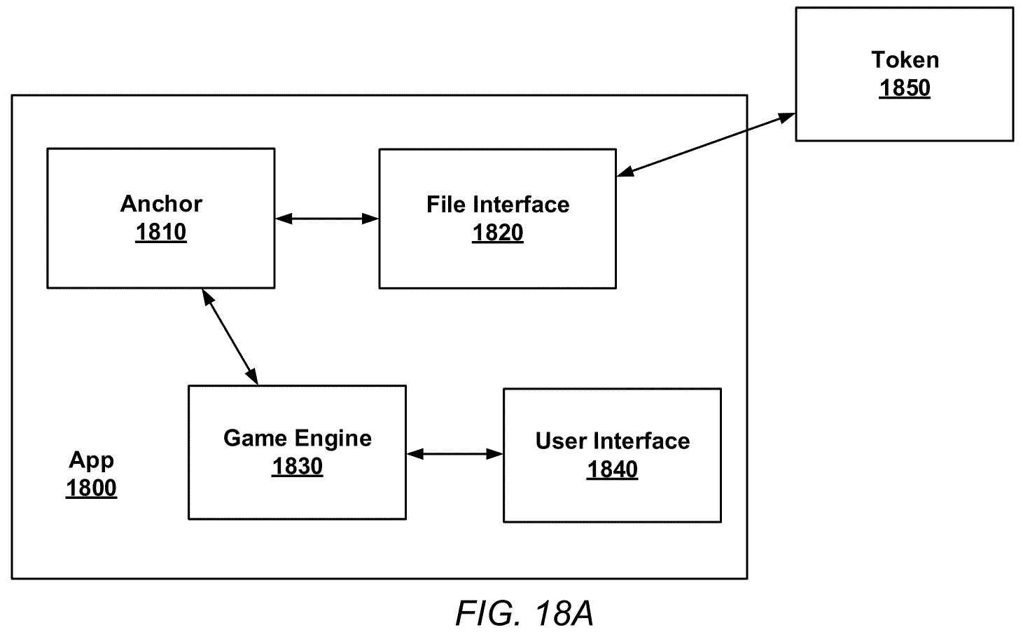

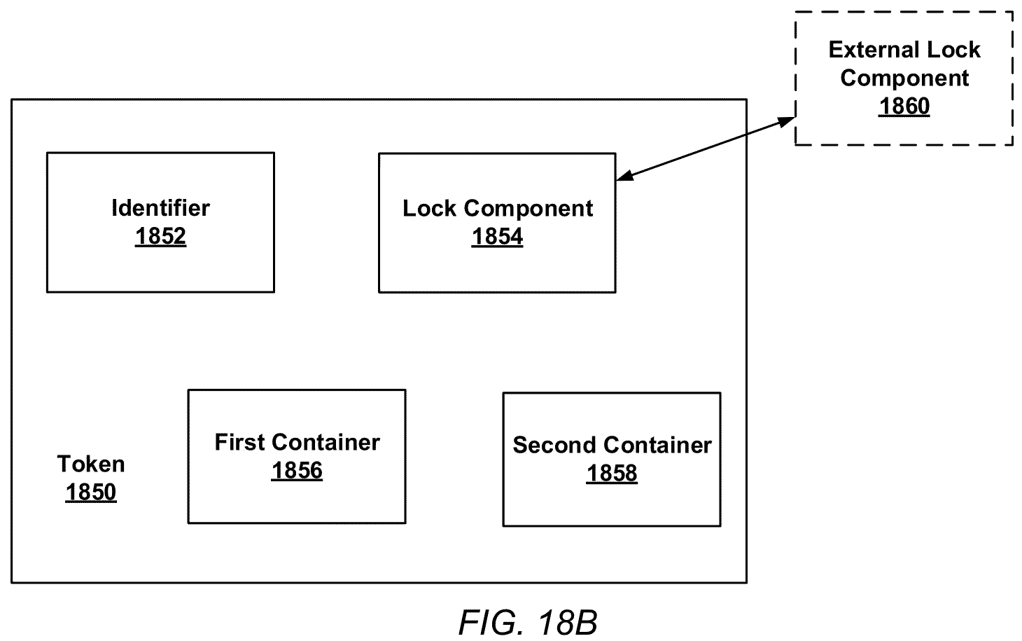

A representation of an application configuration operating in accordance with many embodiments of the invention is illustrated in FIGS. 18A-18B. Applications 1800 may include, but are not limited to, game engines 1830, user interfaces 1840 for communication with users, and file interfaces 1820 for communication with the Internet. In accordance with some embodiments, anchors 1810 may be inserted between game engines 1830 and file interfaces 1820, and be used to verify interactions with tokens 1850. The presence of anchors 1810 can be verified by servers associated with providers of the application 1800 (e.g., an application store). Anchors 1810 may take various forms, including but not limited to binary values. Anchors 1810 may act as filters between file interfaces 1820 and game engines 1830. Anchors 1810 may engage in actions including but not limited to enabling token transfers, blocking token transfers, enabling elected portions of functionality associated with tokens 1850, and disabling elected portions of functionality associated with tokens 1850. Anchors may operate by, but are not limited to associating and/or disassociating lock functionality with tokens and/or containers of tokens 1850. Users, utilizing user interfaces 1840 may initiate token 1850 transfers to and/or from applications 1800 (i.e., importing/exporting). In such cases, anchors 1810 may be used to verify that the token(s) 1850 are in conformance with rules, including but not limited to, rules identifying what tokens may be imported/exported from/to the application 1800. Rule compliance can be determined by matches between data associated with anchors 1810 and data associated with tokens 1850. Anchors 1810 may, in response to user actions, generate logs to be sent to intermediaries including but not limited to servers associated with application providers.

Tokens 1850, in accordance with numerous embodiments of the invention, may include but are not limited to identifiers 1852, lock components 1854, and one or more containers 1856, 1858. In accordance with some embodiments, the lock components 1854 may be associated with optional external lock components 1860. As indicated above, identifiers 1852 may facilitate actions upon matching anchors 1810. Lock components 1854 and external optional lock components 1860 may control access to at least one of the first container 1856 and second container 1858, Control may involve but is not limited to at least one of enabling access by facilitating and/or performing decryption, and enabling access by facilitating and/or performing access control determinations. In accordance with various embodiments, access control determinations may be based on one or more policies included in the lock component 1854 and/or external optional lock component 1860. External lock components 1860 may be operated by servers that are controlled by the application provider that provides the anchor element.

Locks configured in accordance with several embodiments of the invention may include smart contract elements. NFT platforms in accordance with a number of embodiments of the invention may implement various marketplace intermediaries to enable users to conduct token transactions. Such transactions may enable users to engage in the sale, rental, and/or loaning of tokens, guided by the smart contract elements. Smart contract elements may, when activated, initiate payment to parties associated with, but not limited to, intermediaries. In such cases, the size of the payment may be determined based on the transaction(s) causing the activation of the relevant smart contract. Additionally or alternatively, smart contracts may initiate an unlocking of locked containers.

In accordance with numerous embodiments, at least a portion of the lock element/components may be located externally to the tokens. For example, lock components may be stored in database records maintained by and/or accessible by intermediaries. Entities including but not limited to, keys to decrypt locked containers may be stored in such databases and/or obtained in response to the reporting of a transaction being performed. Interactions with lock elements may trigger book-keeping events by intermediaries and lead to charging third parties (e.g., application creators) pre-agreed amounts, and/or amounts based on transaction values.

Ongoing ownership of tokens may be profitable to owners through producing residual profits. Residual profits may come in various forms, including but not limited to loaning, staking, and/or indirect revenue. Example indirect revenue may be when a shield is used in a game to make a player wealthier in battle. Staking may refer to the act of placing a token in escrow for the duration of a membership of a group that performs validation for a Proof of Stake blockchain. A group member who misbehaves, according to a sufficient number of other members, may have a portion of their stake slashed, e.g., taken away from the escrow, not to be returned to the owner as the owner leaves the group.

In accordance with several embodiments, tokens may represent investments that provide the holder with an income stream. For example, the buyer of token A may acquire the rights to 0.1% of the profits of the sale of widget B by company C, minus any royalties owed to other stakeholders. As long as this user holds on to token A, he can be provided with such profits. However, token A may also have an associated royalty policy that specifies that a precious owner of token A gets 5% of the royalties that the buyer receives. When the sale of widget B results in a $10,000 profit, the current holder of token A may be given 95% of $10, and the previous owner may be given 5% of $10.

Content creators can specify a range of royalties that may be provided to (any number of) future owners. Content creators may, for example, specify that each of the future owners can take no more than 0.5% of the revenue of a transaction, but are free to take less to increase the incentive for promotion of future owners.

In accordance with many embodiments, token owners can determine their royalties for future sales and/or rentals of the token, within some bounds. Example limitations may include but are not limited to how much is left to be distributed in terms of royalties and boundaries that are set by content creators and/or previous token owners. In accordance with a number of embodiments, current token owners may be prevented from setting their own royalties and/or may be able to set the royalties of the next owner, also subject to some limitations.

In accordance with various embodiments, royalty policies may be associated with roles tied to transacting with tokens. For example, a royalty may be specific to the third buyer of a token. In some cases, royalty policies may be associated with creating derived tokens that meet certain criteria. Example criteria may include but is not limited to being viewed by at least one million users, being sold for more than ETH 60, and/or being rented more than 1000 times, each rental being done at a cost that exceeds $0.25. Thus, the royalty policies can be associated with any role, event and/or achievement that is specified in the royalty policy, even when the party that can satisfy the role is unknown.

Systems and methods in accordance with various embodiments may enable the assignment of royalties to users whose identities are not yet known. For example, certain policies may enable the assignment of royalties based on roles, including but not limited to “first party to purchase the NFT”, “Fifth party to purchase the NFT”, and/or “First marketplace to mint the NFT” (for instances like when a marketplace curator is involved in improvements to the asset). In accordance with a few embodiments, royalties can be determined a priori. For instance, royalties may be determined before the purchase, rental, and/or minting that they relate to. As an example, a content creator can determine the royalty assignment for different roles. Royalty assignments may be a priori known, which may allow those inspecting a token to be able to determine what royalty will be earned for what role (e.g., the second buyer of this NFT).

Royalties do not need to be tied to sales and can also be tied to other events, including but not limited to rentals, requests for information, creation of accounts, etc. In accordance with many embodiments, the qualifying event(s) tied to the payment of royalties may be the generation of derived tokens.

Systems may not be limited to situations in which ownership transfers are performed, as these may not be the only situations with royalty payment requirements. They may also, for example, be required when tokens are rented and/or loaned, regardless of which party pays the royalty. The royalty requirement in an instance where Alice loans an NFT to Bob may be specified by a rule associated with the NFT, for example. The determination that royalty payments are due in such situations may be performed differently from those involving the determination that ownership transfers have been performed. Specifically, the way of determining may depend on the nature of the royalty-associated action. For example, in the example of token rentals, the determinations may be performed by, but are not limited to, digital wallets associated with renters and/or rentees, rendering units associated with the renters and/or rentees, marketplaces that act as intermediaries for renting, the digital wallets of token owners, and/or bounty hunters that collect indications (such as ratings of content) that users (such as Bob) have had access to content (such as the content of Alice’s NFT).

Systems and techniques directed towards enabling in-app transactions, in accordance with various embodiments of the invention, are not limited to use within NFT platforms. Accordingly, it should be appreciated that applications described herein can be implemented outside the context of an NFT platform network architecture and in contexts unrelated to transactions directed to fungible tokens and/or NFTs. Moreover, any of the systems and methods described herein with reference to FIGS. 18A-18B can be utilized within any of the NFT platforms described above.

### Copyright-Directed Functionality on NFT Platforms

Systems and techniques in accordance with many embodiments of the invention may be directed towards protections against imitation. Systems may be applied to enable entities including but not limited to independent content creators and small businesses to identify and report theft and unlicensed use of their creations. Such systems, additionally or alternatively, may be applied to enable content contributors and/or consumers to obtain licenses that enable them to use incorporate copyrighted and/or private content.

### A. Content Similarity Detection and Prevention Mechanism

Systems in accordance with several embodiments of the invention may be used to assess the similarity of developed content. Systems may enable automated determinations that two content items are sufficiently different to be considered separate entities.

In a number of embodiments, degrees of difference may be quantified in various forms. For example, the similarity between digital assets may be assessed through the lens of hamming distance. Hamming distance, in relation to two binary strings of equal length, may refer to the number of bits, at equivalent places in the string, that have differing values. Additionally or alternatively, similarity between digital assets may be assessed by vector distances between vectorized descriptions of the digital assets, as will be elaborated on below. In accordance with some embodiments can depend on the density of items in given areas. Additionally or alternatively, vectorized descriptions can be determined according to particular system settings. For example, content creators may select particular exclusion zones, encompassing content within particular degrees of similarity to certain assets.

In accordance with many embodiments of the invention, exclusion zones may be determined by content creators. Specifically, content creators can choose larger exclusion areas at a future cost, which can be expressed and implemented in a variety of ways, including but not limited to, affecting royalty rates, affecting ownership duration, and/or payment of fees. In some cases, determinations of similarity may be performed using comparisons of vector distances and/or using human assessments. Human assessments may include but are not limited to using experts to review items.

Systems in accordance with certain embodiments may facilitate the automated distribution of licenses and/or collection of license fees. Fees can be expressed as one-time fees for including already owned content into new content and/or as fees that depend on the usage of the new content. Usage-dependent fees may include but are not limited to, fees per access, fees per sale, fees per transaction, etc. Systems may thereby create content protection operations that are highly flexible. Such systems may be used to incentivize the usage of content and the associated (automated) funneling of royalty payments to content producers.

Automating determination of when licenses are necessary may provide several benefits for systems operating in accordance with a number of embodiments of the invention. Specifically, systems may avoid abuse in contexts where producers of new content are not willing to take a license and/or where new content is, at least in part, based on existing content. Systems may, additionally or alternatively, incorporate and facilitate the distribution of licenses. Therefore, by facilitating the licensing of content, systems in accordance with several embodiments of the invention can benefit original content creators and/or provide automated avenues for obtaining content licenses. Together, these related matters may fuel further creativity on the Internet, for entities including but not limited to content producers without big budgets for advertising and content policing. Further, these benefits may exist without being dependent on the manual effort of admins.

Content utilized by systems operating in accordance with several embodiments may involve but is not limited to, one or more content containers and one or more smart contracts. Content may, additionally or alternatively, exist in the form of tokens including but not limited to NFTs. Smart contracts may incorporate but are not limited to licenses for the rental, use, and/or purchase of content. Smart contracts may include the terms of such licenses, which can be reviewed by any prospective parties. Additionally or alternatively, smart contracts may include descriptions of rights needed to use the underlying content.

Systems in accordance with a number of embodiments of the invention may include content classification methods. Content classification methods may take potentially composite content elements and generate one or more containers. Individual containers may be associated with classifications of the content in the container. Example classifications can include but are not limited to audio files, still images, video files, executable elements, policies, etc. The content in these containers can be further divided into sub-containers. Additionally or alternatively, individual sub-containers may be associated with more specific classifications. In accordance with many embodiments, content in sub-containers can be further broken down even beyond sub-containers. In this application, all such containers may be referred to as containers, except where needed to clarify the functionality. Containers and sub-containers may include content data and/or references to content data. Such content data may include composite content elements and/or content classification elements.

Composite content elements may be created from one or more content types. For example, movies with audio may be composite content elements, as they may be composed of visual series elements and audio elements. Another example of composite content elements may be a new type of wall to be used in Minecraft(™), where it may include a visual/functional representation that corresponds to the perceived properties of the associated wall, experienced by a player in a game. Functional representations may be expressed as executable elements, including but not limited to, applications, scripts that can be executed, rules and/or policies that can be interpreted by other executable elements, etc. Composite content elements may be in the form of art pieces with visual, audible, and/or tactile components. When such components exist, they may react to the presence of viewers, as determined using sensors associated with displaying entities. As mentioned above, composite content elements may, additionally or alternatively, incorporate only one type of content. One such example may be a JPG rendering of a painting.

Executable elements may, for example, be classified based on their input/output behavior. Example classifications may depend on, but are not limited to, whether executable elements take input from a keyboard, a pointing device, a microphone and/or a network connection. The executable elements can be classified based on whether the outputs are audio, tactile, and/or visual responses. Furthermore, the executable elements may be classified in terms of the logical flow they express. In accordance with a few embodiments, classifications may correspond to one or more common structures. One such structure may compare inputs from two or more players and determine which one was most precise, the luckiest, and/or the fastest. In such cases, determinations may be based on comparisons with one or more threshold values.

Policies may describe how content elements are used. Example use policies may include but are not limited to, usage solely by the owner, by anybody with access rights, by one user at a time, when specified digital resource(s) are available, when content elements are executed in trusted execution environments (TEE) and/or digital rights management (DRM) modules, when locations of the executing devices have been provided (e.g., GPS) and verified to satisfy some requirement, etc. Policies can, accordingly, be sub-divided into sub-containers and classified according to one or more such types.

Systems in accordance with several embodiments of the invention may utilize various vectorization techniques. In such cases, content elements in containers may be described using one or more vector elements. Vector elements may correspond to multi-dimensional mappings of content specifications, functionality, and/or positions within various dimensions. For example, such positions may correspond to discrete selections and/or degrees of the extent to which features may be present. One such feature may, for example, be the volume at which an individual audio source may be played, relative to the volume of other audio sources. Here, the sound of a trumpet may correspond to one audio source and the sound of a piano to another sound source. Different content may be expressed in their corresponding vectorized spaces using different sets of rules. For example, content elements that include audio can be expressed using dimensions that correspond to the volume of one or more features of the audio file; at the same time, doing this may not be considered a meaningful way to express a JPG image. JPG images, on the other hand, may be expressed in terms of the color scale they use, the average color temperature of the images, and/or the distribution of element sizes. An element’s size may correspond to identified image segments after filtering techniques have been applied. One such filtering technique may increase the contrast until the resulting image satisfies specific criteria (e.g., using only ten distinct colors).

The vectorization of executable content files may map the files into sets of dimensions corresponding to characteristics such as the run-time behavior and/or the type of output the files produce. Some dimensions of vector spaces may correspond to the types of classifications that classification entities are capable of performing. Other dimensions may correspond to mappings that do not correspond to previous classifications. For example, one or more Fast Fourier Transforms (FFTs) may be computed relative to individual content elements and used to express one or more vectors. For example, one such vector may correspond to the FFT of a still image; another vector to the FFT of a series of changes performed to one portion of a movie; and yet another to an FFT of an audio file that may be played as the movie is rendered.

Vectorized descriptions of composite content elements may include collections of vector elements such as those described above. Additionally or alternatively, vectorized descriptions may include indications of classifications in a manner that is separate from the vector data. Indications can be used to determine the meaning of associated vector data. For example, when an indication specifies that a content file includes an audio element, then a portion of the vectorized description associated with this indication may include vectors that are specific to audio elements. Such vectors may include but are not limited to collection descriptors of instrument types and their relative prominence. Prominence, in accordance with some embodiments, may be determined according to factors including but not limited to duration, volume, and/or entropy. Additionally or alternatively, when indications specify that content includes tactile output patterns, then portions of the vectorized description associated with such indications may include FFTs of the tactile output patterns for given user input and/or other triggering events. In such cases, the vectorized description may include but is not limited to at least one of a type identifier (such as the presence of data for tactile feedback, and/or the use of animation in response to user actions) and a quantification (such as a description of a relative volume of one content elements relative to another, and/or the brightness of a moving object).

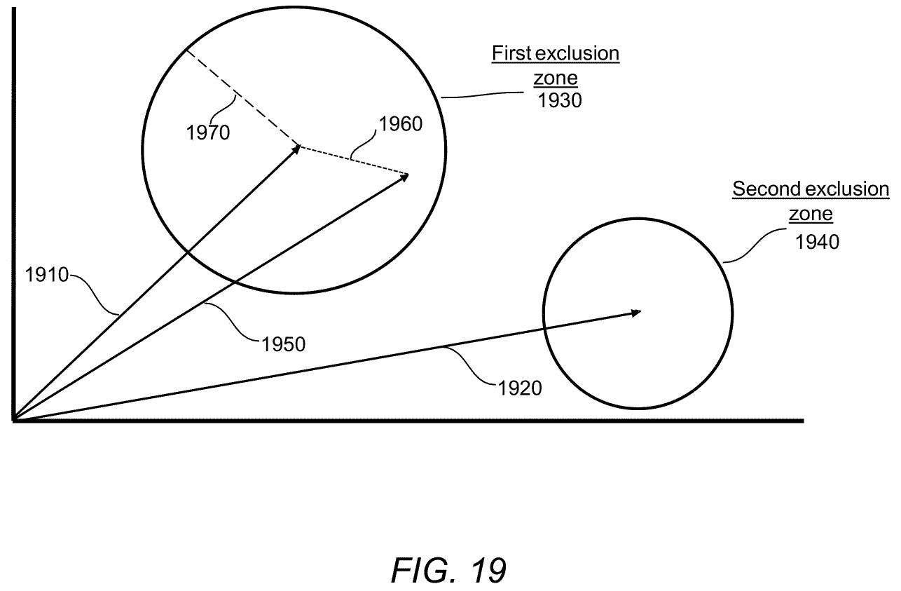

A graphical representation of two vectorized descriptions generated in accordance with numerous embodiments of the invention is illustrated in FIG. 19. FIG. 19 depicts a first vectorized description 1910 of a first content element, and a second vectorized description 1920 of a second content element. The first exclusion zone 1930 associated with the first vectorized description 1910 may be different than the second exclusion zone 1940 associated with the second vectorized description 1920. When a new item corresponding to a violating vectorized description 1950 includes content that is too similar to the first content element, based on the first exclusion zone 1930, it may produce a license requirement. In accordance with certain embodiments, vectors can be illustrated in vector spaces spanned by two or more dimensions. The distance 1960 between the first vectorized description 1910 and violating vectorized description 1950 may be smaller than the radius 1970 of the first exclusion zone 1930. As mentioned above, this can correlate to excessive similarity. However, the violating vectorized description 1950 is outside the second exclusion zone 1940. As such, the violating content may not need to include a license to the content corresponding to the second vectorized description 1920.

Vectorized descriptions of content elements may be performed at various points in time. For instance, vectorized descriptions may be performed as content is accessed. Additionally or alternatively, vectorized descriptions may be performed at times when content is incorporated into tokens. In such cases, the tokens may include and/or reference the vectorized description(s). Vectorized descriptions may also be stored in databases and used as part of inventories of known content elements.

When vectorized descriptions are stored in databases, they may be identified based on database keys and/or parts thereof. For instance, database keys may be values computed based on collections of classification indications and/or unique counters. Unique counters may include but are not limited to cryptographic hashes of vectorized description, simple serial numbers assigned to records, and/or values associated with the originator(s) of the content. Database keys may point to one or more entries in databases. Users can therefore provide database keys in database queries and receive one or more records as a response. Such records may include vectorized descriptions. Additionally or alternatively, records may include references to owners, references to tokens, and/or references to originator(s).

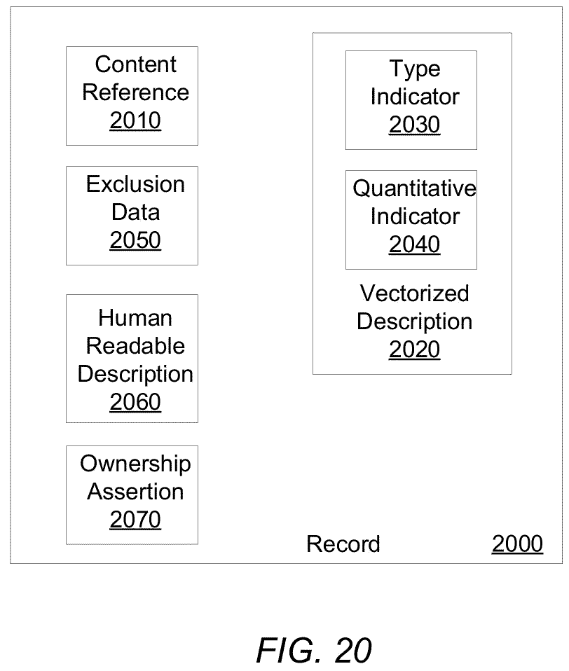

An example database record in accordance with many embodiments of the invention is illustrated in FIG. 20. Records may include, but are not limited to a content reference 2010, a vectorized description 2020 of the content associated with content reference 2010, a type indicator 2030, and a quantitative indicator 2040. The type indicator 2030 may, for example, indicate that the content corresponding to the vectorized description 2020 has a trumpet solo. Moreover, the quantitative indicator 2040 may indicate the duration, in seconds, of the trumpet solo. Optional exclusion data 2050 may indicate an exclusion zone, which may be expressed as a minimum distance to other elements without the need to acquire licenses. A human-readable content description 2060 may include one or more labels of the content. Example labels may include but are not limited to “music”, “jazz”, “trumpet”, “Ray Charles”. An optional ownership assertion 2070 may include associated audit path data. The audit path data may indicate the provenance of the content corresponding to the record, including but not limited to, the identity of the original content creator and/or any successive owners of it.

Databases may be structured based on vectorized descriptions. For instance, related and/or similar vectorized descriptions may indicate nearby logical locations in databases. This can enable searches for vectorized descriptions, and/or references to the associated content. Such searches may be based on similarity measures of the vectors and/or the associated classifications associated with these vectors. In accordance with some embodiments, at least some vectorized descriptions can include arrays of binary selections. Binary selections may indicate the correspondence of content along binary selection axes. For example, one such axis may be the classification of whether an item can be used as a weapon in a game, another axis may be whether the item uses a rendering package for the display of hair, and another whether the item corresponds at least in part to a tactile output. Additionally or alternatively, vectorized descriptions can be made up of a very large number of such binary classifications.

Systems in accordance with numerous embodiments of the invention may enable content creators to acquire the rights to use content created and/or owned by others. Moreover, systems may include references to agreements specifying such rights in tokens. For example, a content creator may acquire the right to use a musical score as background music to a nature movie they produced. As this content creator generates tokens including the nature movie, the musical score, and/or references to the two, they may also indicate the relevant agreement(s) in the generated tokens. This can be done through modes, including but not limited to, incorporating the agreement and/or reference thereof. Such references may, include URLs and/or other resource locators that point to unique logical and/or physical storage locations (at which the agreement(s) may be stored). An example location may be associated with a domain and path, and/or with a position in a blockchain. References may, additionally or alternatively, indicate the identity of other tokens that may be associated with the content containing the nature movie.

In accordance with many embodiments of the invention, tokens may include, but are not limited to content elements and vectorized descriptions of the content elements (and/or references to such vectorized description). As such, tokens may be compared with other tokens and/or compared with representations of known content that has not yet been tokenized. Comparison can be performed by identifying records that point to nearby positions in one or more of the vector spaces indicated by the vectorized descriptions. Compatible vectors may be considered vectors that correspond to descriptions of similar types of data. For example, two or more vectors may all correspond to audio and/or FFTs of still images. In such cases, the aforementioned comparisons can be performed through the relevant vectors.

In accordance with numerous embodiments of the invention, the comparison of two or more vectors can be performed using traditional linear algebra techniques. In such cases, the output may be in the form of vector distances in spaces spanned by the vectors being compared as suggested in FIG. 19. Vector distances may be representative of differences between two or more compared vector descriptions. When In instances where vector distances are especially small, systems may thereby determine vector descriptions to be very similar. Such determinations may be based on vector distances falling below particular thresholds. When vector distances have moderate differences, then the two or more vector descriptions may be determined to be similar. Moderate differences may be based on vector distances falling under a first pre-specified threshold but above a second pre-specified threshold. Finally, vector distances above particular thresholds may be determined to be dissimilar. Alternatively or additionally, quantitative similarity scores can be computed by systems operating in accordance with various embodiments. Through such operations, the similarity of two or more vector descriptors may be classified as belonging to set categories, where there can be two or more such categories that identify distance. In such cases, there may be a multitude of differing quantitative similarity scores possible. These are only two of the many alternative ways to score similarity between two or more vectorized descriptions, and accordingly, their associated content.

Methods in accordance with some embodiments of the invention may involve techniques to map similarity scores to actions. For example, when two content elements have similarity scores that satisfy a first rule, then a first action may be taken. Additionally or alternatively, when similarity scores satisfy a second rule, then a second action may be taken. One example rule may be that the score indicates a difference less than a threshold, such as 2.5. Another example rule may be that the score indicates that the two content elements are especially similar according to a particular assessment, as shown above. In accordance with some embodiments, exclusion zones may be associated with tokens. As such, a third example rule may be that the score indicates that the two or more content elements have a similarity score suggesting a distance smaller than a certain value expressed in one of the corresponding tokens.

In accordance with a number of embodiments, large exclusion zones may correspond to lower tolerance for similar content. As mentioned above, similarity may be judged based on the distance between the associated vectorized descriptions. Exclusion zones can be expressed through various modes including but not limited to tokens, records stored in databases, and/or policies incorporating pre-approved measures.

Particular tokens may have multiple exclusion zones. For example, a first token may be associated with two exclusion zones (e.g., Z1 and Z2). Such exclusion zones may be representative of different degrees of similarity. Any content falling within zone Z1 may be automatically rejected from systems operating in accordance with the invention unless it includes a license indicating a right to use the relevant content. At the same time, any content falling within zone Z2 may carry less hard-handed responses. For example, content falling within zone Z1 may result in admin-aided reviews of the two or more content elements (unless there is a license involved). In response to instances where two or more content elements exist in the same exclusion zone(s), systems may make determinations as to which element(s) should be rejected from the systems. For example, admins may scrutinize two or more content elements and determine, potentially using entities including but not limited to terms of service, policies, and/or legal guidelines, whether one of the two items should be rejected.

For systems operating in accordance with many embodiments, content creators may, by requesting large exclusion zones, be required to make some concession/tradeoff in exchange. By doing so, they may, for instance simultaneously agree to limit the duration of ownership. For example, ownership may be limited to a max of 12 months. After this threshold time, the content associated with the vectorized description and associated exclusion zone can fall into the public domain. As such, the content may then be permissible for other content producers to utilize in various manners in their content. Content creators may, additionally or alternatively, choose large exclusion zones by agreeing to perform up-front payments. Such payments may that may be used to fund important functionalities, including but not limited to hosting content at reduced rates for schools and non-profits. In accordance with certain embodiments, combinations of tradeoffs can be selected. Such selections may be facilitated according to menus and/or visual interfaces. Tradeoffs may affect but are not limited to, the size of the exclusion zone, the size of the royalty payment, the duration of ownership, the size of an up-front payment, and more.

Using interfaces, users may select buttons to increase and/or reduce levels of protection. For example, a certain selection may correspond to an exclusion zone with a 200% larger volume. In accordance with several embodiments, users may have the capacity to select to obtain protection forever. Additionally or alternatively, users may select time-limited protection (such as only for 12 months). Budget-minded users may choose to have time-limited protection alongside smaller exclusion zones. Such selections may correspond to zero-cost and/or free licenses. in accordance with numerous embodiments, exclusion zones may remain in place even after the end of time-limited protections. Such exclusion zones may, while no longer carrying license requirements, still be used to block others from claiming the portions of the vector space (i.e., classifications of content) later. Thus, exclusion zones with (expired) free licenses may correspond to portions of vector space that cannot be owned by others but which can be used freely. Based on the selections, costs may be determined. In accordance with various embodiments, costs may be one-time costs and/or depend on content usage. For example, certain costs may require cuts of the royalty and/or fixed charges per license.

Content rejected by systems operating in accordance with some embodiments of the invention may lead systems to block the incorporation of the content in tokens, and/or generate tokens that include indications of the rejection. This indication of rejection may cause the tokens to be filtered out, blocked, and/or otherwise be limited on what actions can be applied to them. For example, a rejected token may be blocked from being sold on a given exchange.

When vectorized descriptions related to content elements are verified not to be within the exclusion zone of any other content, and/or when licenses corresponding to each of the exclusion zones can be obtained, then the content elements may be approved. Approved content elements may be associated with their own exclusion zones, which may in part be determined based on user selections made by users associated with the content elements. Approved content elements may also be minted into tokens. Additionally or alternatively, tokens can incorporate certificates generated by authorities. Certificates may, for example, indicate that the tokens do not require any additional licenses. The certificates may describe the content through means, including but not limited to, vectorized descriptions generated from the content. Certificates may be blocked from being generated when the content is within one or more exclusion zones, without possessing the corresponding licenses.

Tokens that are not blocked may include validity indicators indicating that the associated content was accepted/not blocked. Such validity indicators may include, but are not limited to digital signatures generated by authorities. Digital signatures may reference and/or be based on the content, their associated vectorized descriptions, and/or token identifiers associated with the content. The authorities that generate the aforementioned digital signatures may be trusted entities with which users can find recourse in cases of mistake. Additionally or alternatively, the authorities may be bonded entities that can be sued in cases of mistakes. Additionally or alternatively, the authorities may be government entities that validate content. Additionally or alternatively, the authorities may be entities that do not provide any assurance, but whose reputation(s) depend on being accurate. In accordance with numerous embodiments, tokens may include multiple validity indicators, corresponding to differing authorities. For instance, each such validity indicator may include an indicator of the identity of the authority. Authority identifiers may include, but are not limited to digital certificates on the authorities’ public keys, wherein the public keys may be used to verify the digital signatures of the validity indicators.

The costs associated with establishing exclusion zones may exist in the form of fees paid when associated tokens are transacted. Transactions may include but are not limited to being bought, sold, licensed, and/or lended. In accordance with several embodiments, different fees may apply to different types of transactions. Additionally or alternatively, fees received by systems operating in accordance with many embodiments may be applied to various uses of the content of the tokens, such as rendering of contents. Fees may be paid to cover the costs of managing the services described in this application, including but not limited to generating validity indicators. Additionally or alternatively, fees may be used to pay for the cost of storage of items, including the tokens with the specified exclusion zone. Some exclusion zones may be associated with no fee at all. As indicated above, other, greater exclusion zones may be associated with larger fees.

The choice of exclusion zones may, additionally or alternatively, dictate the amount of royalties required for the use of the associated content. For example, a content creator that selects a large exclusion zone may be forced to commit to a low royalty rate for anybody who wishes to license the content, whereas a content creator that selects a smaller exclusion zone may be free to set the license fees in any way they wish.

Exclusion zones may be specific to particular uses of content in tokens. For example, a content creator may specify one small exclusion zone to apply to tokens and/or content that includes promotional elements specified by the content creator. Promotional elements may include but are not limited to advertisements of content created by the content creator. Additionally or alternatively, larger exclusion zones may be associated with content provided by educational institutions and non-profits, and a yet-larger exclusion zone may be used for any other content.

In accordance with some embodiments, exclusion zones may be generated by authorities based, at least in part on vector space density in regions associated with individual vectorized descriptions. Doing so may enable novel works that are registered to be assigned larger exclusion zones than more “derivative” works, similar to previously recorded content. In other words, systems operating in accordance with some embodiments may experience a gradual shrinking of the size of exclusion zones in particular vector neighborhoods.

Vector space density may control the available options for exclusion zones that content creators select from. In crowded vector neighborhoods, content creators may be allowed to select exclusion zones of certain magnitudes (e.g., Z1 and Z2) which may be associated with distinct rules and policies. Less crowded vector neighborhoods may enable content creators to have larger exclusion zones to choose from. As such, for content in a less crowded vector neighborhood, content creators may be allowed to select from Z3 and Z4, wherein Z3 & Z4 are governed by the same rules and policies as Z1 & Z2, respectively, but with greater magnitudes than their counterparts. The crowdedness of vector neighborhoods may be determined, for example, by clustering a set number (e.g., 1000) of the closest vectorized descriptions of content relative to a given input content element. In such cases, the average minimum distance between each of these vectors and their closest neighbor, respectively, may be determined. Additionally or alternatively, other density assessments can be performed to determine crowdedness.

When users wish to tokenize new content elements, these new content elements can be processed to generate vectorized descriptions. In most instances, the type determination may be automated from file extensions, including but not limited to, JPG, PNG and/or WAV. In some instances, the determination of type may be performed by asking users to provide one or more selections, casting the type accordingly. After types have been determined, one or more classifications and/or one or more mappings to a vector space can be performed. Systems operating in accordance with many embodiments may thereby produce representations of the content as vectorized descriptions.

Systems may, additionally or alternatively, identify collections of nearby vectorized descriptions in the spaces that may be spanned by the representation. Identifications may be performed on a per-vector basis, producing one or more distances from nearby vectors of various vectorized descriptions. Vectorized descriptions within spaces may each have corresponding exclusion zones. Systems may determine whether one or more vectors are close enough to the new vectorized description that the new vectorized description falls within the exclusion zone of the corresponding one or more content elements. In accordance with a number of embodiments, vectors and/or collections of vectors falling within the exclusion zone of other vectors may be considered “matches.” Matches can be determined by gathering all vectors within a maximum exclusion distance from the new vector and determining whether the associated exclusion zone(s) are sufficiently large to establish a match. Additionally or alternatively, matches can be determined by clustering vectors and determining distances between the vector(s) of the new content and the vectors of the cluster. Cluster determinations may be based on quick comparisons of the vector descriptions and/or precise but more computational clustering methods. Once the distance is determined, systems may confirm whether the distances fall short of the distance associated with the exclusion zone (e.g., the radii of the circles of FIG. 19). Variations of these methods can also be performed.

Systems may determine when matches are associated with usage policies allowing and/or requiring the creators of the new content item to obtain licenses. When users have already obtained one or more licenses (presented with the new content), systems may determine the validity of the licenses. When licenses are required but haven’t been obtained, systems may provide lists of one or more required licenses along with associated terms. For example, one set of terms may say that every time the licensed content is played as part of the rendering of the new content, a license fee of $0.021 needs to be paid to the licensor. In accordance with some embodiments, licensors may be identified in the set of terms and/or may be identified separately. The terms associated with content may describe information including but not limited to the price of licensing the content, durations during which a license may be necessary in order to use the content, and descriptions specifying different types of uses and their associated requirements.

When no matches are detected, no license may be required. Conversely, a license may be required when at least one match is detected. In some instances, a piece of content may be determined not to be licensable for reasons including but not limited to owner preferences. In some instances, the creators of the new content may not wish to pay for the license(s). When this occurs, they may choose to modify the content to reduce the similarity, and therefore not require a license. For example, a user may be told that she needs a license to a given soundtrack, and that this costs $0.002 per rendering of the content that includes the licensed content. She may think this may be too expensive, and therefore decide to replace the audio elements that caused the triggering of the requirement for a license, and then submit the resulting new content for consideration again. Alternatively or additionally, systems may provide suggestions for other alternative types of content that could be used and/or list their associated license costs. Doing so may enable creators to decide whether they wish to use any of the alternative content elements. When users agree to license content, systems may automatically incorporate the licensed content and/or enable creators to do so themselves through their own content creation/modification tools.

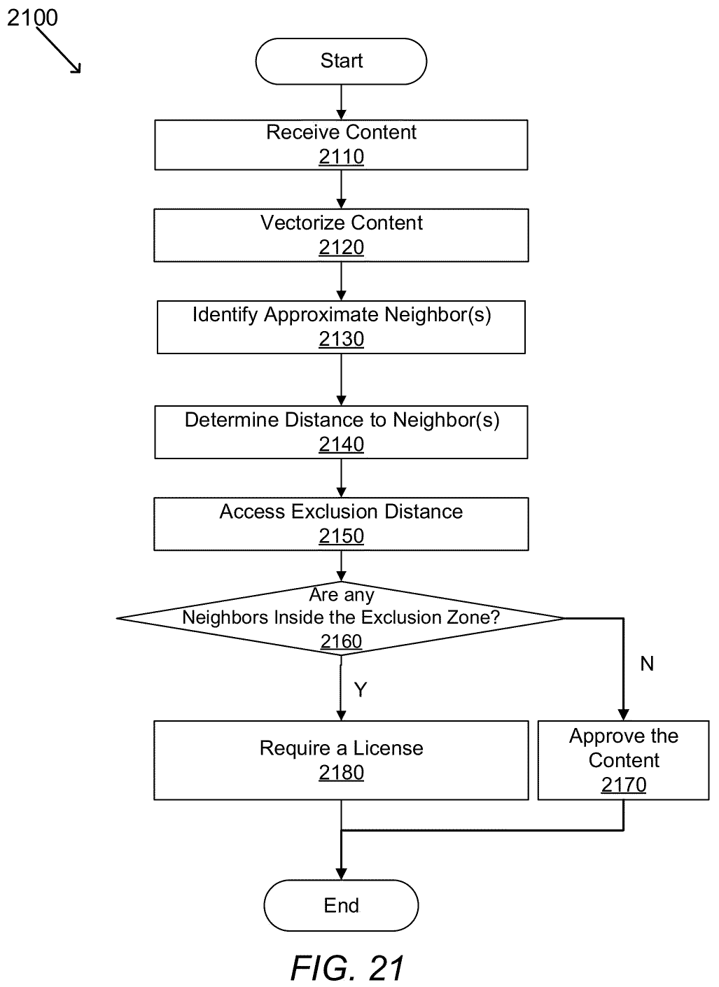

A process in accordance with various embodiments of the invention, for the determination of whether a new content element requires a license, is illustrated in FIG. 21. Such determinations may be based on being within the exclusion zone(s) associated with the vectorized description of that content. Process 2100 receives (2110). As indicated above, the content may be received in various forms including but not limited to tokens. Process 2100 generates (2120), a vectorized description from the content, including but not limited to, one or more type indicators and one or more quantifiers, such as vectors. Process 2100 identifies (2130) a cluster of nearby nodes. The nodes may correspond to approximate neighbors in the vector space. Additionally or alternatively, the vectors can be stored in records. Vectors may further correspond to vectorized descriptions. A large number of heuristic methods can be used to identify neighbors including but not limited to the use of K-dimensional trees and quantization. K-dimensional trees, also known as K-d trees, can represent generalizations of binary tree searches to multiple dimensions. Quantization can be performed through modes, including but not limited to, using K-means algorithms, where data may be mapped onto centroids. Process 2100 determines (2140), for each of the identified neighbors and/or approximate neighbors, a distance to the vectorized description associated with the content. Process 2100 determines (2150), the associated exclusion distance, including but not limited to exclusion data, of the approximate neighbor.

Process 2100 determines (2160) whether the vector corresponding to content elements is inside the exclusion zone. When it is, process 2100 continues to (2180), otherwise to (2170). When the corresponding vector is outside the exclusion zone, process 2100 approves (2170), the content elements. Approving content elements may entail generating certificates by authorities; specifying that content elements do not require a license; generating a record; and/or minting tokens using content elements. When the vector is inside the exclusion zone, process 2100 requires (2180) a license. Users may be notified what license may be required, what the terms and required rights are, and be asked whether they wish to acquire the license and/or modify content elements.

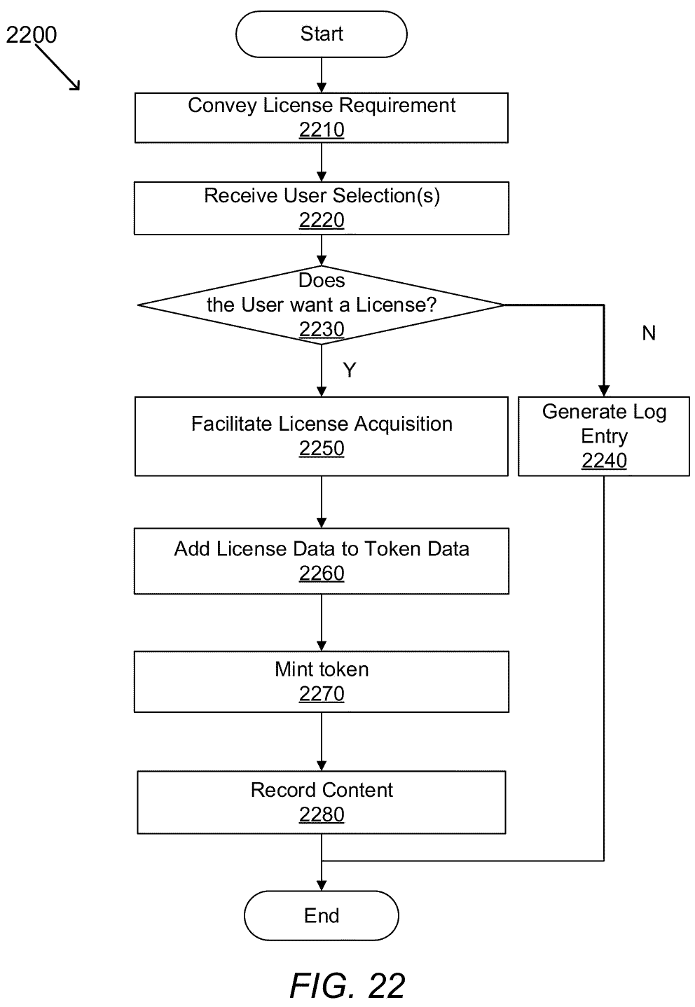

A process for determining whether any license is needed for the distribution of content in accordance with some embodiments of the invention is illustrated in FIG. 22. Process 2200 conveys (2210), to users the requirement to acquire a license for the content elements of the first container to be used in minting tokens. This may include presenting one or more sets of terms, including costs, to users wishing to mint tokens from the content elements associated with the first container. Process 2200 receives (2220) user selection(s). Example user selections may include, but are not limited to, “Obtain license 1”, “Obtain license 2”, “Already have a license” (for which evidence may be uploaded), and/or “Do not obtain license.” Here, license 1 and license 2 may correspond to two different sets of terms. In accordance with numerous embodiments, some licenses (e.g., License 1) may be eternal, pre-paid licenses to use material in the minted tokens. Additionally or alternatively, some licenses (e.g., License 2) may be per-use licenses. Per-use licenses may specify that each time the minted tokens are sold and/or otherwise transferred, a royalty should be paid to the provider of the license. Royalties may be flat fees and/or percentages. For example, a royalty may be the greater value of $5 and 4% of the cost associated with the sale and/or transfer. Other licenses can also be used in accordance with many embodiments, including but not limited to licenses applying to the renting of content, the public display of content, etc. Process 2200 determines (2230), based on the user selection, whether one or more licenses should be acquired. Upon choosing not to acquire a license, process 2200 generates (2240) a log entry to indicate such. Otherwise, process 2200 facilitates (2250) license acquisition. License acquisitions may include the integration of already acquired license(s) with content containers. Process 2200 adds (2260) license data, such as terms and required rights, to the tokens data. This addition may be part of a smart contract. Process 2200 mints (2270) and/or facilitates the minting of tokens based on the compiled token data from (2260). Process 2200 records (2280) the content associated with the content elements and associated data related to the minted tokens.

Systems configured in accordance with some embodiments may enable service providers to construct databases of records with content references and vectorized descriptions of the associated content. Populating these databases may involve processing large numbers of known content elements. Some content elements may have associated ownership and/or origination information, which may be added to the records. Ownership indications may be curated, entered, and/or certified by authorities. For example, museums may provide database entries corresponding to art pieces they own and/or have custody over, indicating ownership in the associated records. Ownership indication may be associated with audit paths that identify which one or more entities, including authorities, have made assertions related to the ownership. Content associated with tokens may have ownership indications already expressed in the token(s). As such, the ownership indications may be entered into the database along with descriptions relating to the corresponding content. Descriptions may include but are not limited to vectorized descriptions, content references, and ownership records with associated audit paths.

In accordance with several embodiments, client-side tools for content publication and/or token minting may determine whether matches exist. Specifically, these tools may assess when content is outside the outermost exclusion zone of (other) known pieces of content. Assessments may be performed through accessing publicly accessible databases, such as blockchains, to determine whether vectorized descriptions in that database, in the general proximity of the vectorized description of the new content, fall within any exclusion zone. When no exclusion zones are encroached, the client-side tools may provide evidence to one or more authorities that can generate certifications associated with the content. The evidence may include but is not limited to data indicating the clustering of vectorized descriptions, identification of the corresponding vector distances (to the vectorized description of the content to be certified), etc. The certification authorities may perform randomized verifications of the evidence and associated data, and/or perform separate searches. These searches can be based on the track record of the entities requesting the certification, including but not limited to, reputations and/or amount of collateral.

In accordance with some embodiments, low-density areas can be identified and their potential assessed. The density of areas can be assessed as described above. Different vector spaces may, inherently, have different apparent densities due to different normalization efforts. Systems may, however, assume unbiasedness within individual vector spaces. In accordance with a number of embodiments, different vector spaces can be compared by applying normalizations of their density at specific points in time, and then determining differences in density on the normalized space after a period of time. Here, one vector space may correspond to rock music, another vector space to classical music, and a third vector space to nature photography. Whereas the two former may have larger similarities, all can be compared in terms of density and changes in density over time. The changes in density may be local to some portion of the vector space, and indicate a greater and/or reduced extent of creativity in such spaces.

Content and their associated vectorized descriptions can be assessed from popularity perspectives. Popularity may be assessed through lenses including but not limited to number of views, number of leases, number of likes, number of sales, the sale price, the lease price, reviews, number of bids, and/or other indications correlated with popularity.

Using density assessments and/or popularity assessments, systems operating in accordance with many embodiments can create automated predictors. Automated predictors may be used to determine information like, but not limited to, what content areas correspond to good opportunities. For example, an area with low density and with one or more very popular content elements, as described by the endpoints of their associated vectorized descriptions can be indicative of great novelty. In comparison, very popular items in dense vector spaces may be indicative of content that complies with existing popular and well-established styles. Not-so-popular content in dense areas populated with very popular items may be considered unlikely to trend. Content elements close in vector space to many popular items (and which exhibit similar popularity trends in early observations as the neighboring elements) may be likely to become popular should they be tweaked and/or promoted by influencers. In accordance with many embodiments, creativity scores can be generated based on vector space density and/or popularity (e.g., low density + high popularity = novel). This and other related measures can be used to generate early predictors of success. The quantification of content into vector spaces using vectorized descriptions can allow for determinations of how to best promote content, including but not limited to, exposing users (with preferences for content in the proximity of the vector space) to the new content.

In accordance with some embodiments, users with rights associated with content elements may select exclusion zones and/or sets of license terms. By doing so, data related to such selections may be associated with the content elements. Data describing the content, and associated license terms, may be stored in databases that may be used to determine, for other content items, when licenses are required. Additionally or alternatively, content may also be associated with certificates generated by authorities. Certifications may be used to confirm compliance with requirements including but not limited to copyright requirements. The satisfaction of copyright requirements may be determined by content being sufficiently different from other content, at the time of the minting.

Systems and techniques directed towards the defense of licensing requirements, in accordance with many embodiments of the invention, are not limited to use within NFT platforms. Accordingly, it should be appreciated that applications described herein can be implemented outside the context of an NFT platform network architecture and in contexts unrelated to similarity assessment for fungible tokens and/or NFTs. Moreover, any of the systems and methods described herein with reference to FIGS. 19-22 can be utilized within any of the NFT platforms described above.

### B. Rights Management for Audio-Visual Content

Systems and methods operating in accordance with many embodiments of the invention may be applied to the identification of ownership rights and the management of creative content, including but not limited to logos, visual artworks, and music. Such methods may provide ingrained defenses governing the republication and derivation of creative works.

The generation of derivative content, including but not limited to the creation of non-fungible tokens (NFTs), may violate copyright and/or trademark protections. Intellectual property rights including but not limited to copyright and trademark rights may be referred to as “IP rights” in this application. Systems operating in accordance with numerous embodiments of the invention may assess derivative use cases affecting audio-visual media creations, including but not limited to paintings, sculptures, sound effects, and/or songs. Further, systems may assist the original creators and/or rightful owners of such audiovisual materials in detecting such use, determining ownership, and compensating the appropriate parties.

Techniques operating in accordance with a number of embodiments may involve but are not limited to performing automatic scene and component analysis on audio-visual works. Additionally or alternatively, techniques may involve detecting content sub-segments that match already-minted and/or stored works on NFT platforms. Additionally or alternatively, techniques may involve taking specified remedial and/or punitive actions when derivation is detected. Example NFT platforms configured to utilize such techniques may be referred to as “media chains” in this application.

Systems operating in accordance with some embodiments of the invention may be configured to scan public database{s) of audiovisual materials. In doing so systems may utilize one or more means of determining when aspects of those materials contain works registered on the media chains as having copyright and/or trademark owners. Hereafter such audiovisual materials which contain registered or otherwise copyright-protected and/or trademarked materials can be referred to as “derivative works.”

Upon detecting protected sub-components within derivative works, systems operating in accordance with several embodiments may check media chains to determine whether the appropriate rights were secured by the derivative works creators, posters, and/or sellers. In certain cases, wherein royalties may be due because of the usage within derivative works, media chains configured in accordance with various embodiments may assess, collect, and/or distribute the proper amount(s) of payment. In certain scenarios, royalties may be split between multiple IP holders, made simple by the nature of smart contracts on the media chains. Derivation of tokens, and associated methods, are disclosed in U.S. Pat. Application No. 17/808,264, titled “Systems and Methods for Token Creation and Management,” filed Jun. 22, 2022, incorporated by reference in its entirety. When the creator(s), poster(s), and/or seller(s) of derivative works do not have suitable permissions to use sub-components, systems may take one or more remedial steps. In accordance with a number of embodiments of the invention, royalties may be paid to the creator(s) of the original sub-component{s).

In media chains configured in accordance with various embodiments of the invention, offers of licenses may be sent to the creator(s), poster(s), and/or seller(s) of the derivative works. The offered license(s) may take a number of forms and/or include a number of restrictions, including but not limited to one-time use, limited use (e.g., not for resale or profit), free use but with proper accreditation, etc. Alternatively or additionally, creators of derivative works may have the capacity to directly sign up for agreements (e.g., licenses) by virtue of searching, browsing, selecting, and/or explicitly using specific pieces of registered art.

In accordance with many embodiments of this disclosure, derivative work creators who use registered content can themselves receive payment. Payment may occur due to reasons including but not limited to placement of advertising. For example, a visual artist might pay “per impression” for each person who views or buys a derivative work that contains their art as sub-image (s). In another example, a songwriter might wish to promote their new video and could offer a clip of it to be included in other derivative works, in exchange for credit and/or a link to their own work. In cases including but not limited to these, the creator of the derivative work could be compensated for “product placement” purposes.

For example, one venue (e.g., a restaurant) may wish for and/or encourage, vloggers to publish content that discloses their location, logo, menu, etc. Such venues may sponsor content that satisfies stated requirements (show logo, favorable view of service) by paying on a per-view basis. Additionally or alternatively, sponsorship may depend on there being a conversion/transaction (e.g., a viewer coming to the restaurant and buying a meal, mentioning the content to get a free drink, etc.). In accordance with some embodiments, owners of registered content may require payment in order for any identifiable content (e.g., logo) to be rendered in the derivative works. Such functionality may be facilitated through non-fungible tokens as indicated above. In these example cases, payment may be made in various forms including but not limited to a flat fee, a per-view fee, etc. Additionally or alternatively, fees may depend on the type of content, such as greater fees for commercial content.

In accordance with many embodiments, content originators may be able to determine what the derivative policies are for certain entities and/or advertisement-concerned venues. Systems may utilize standardized methods including but not limited to WiFi, Bluetooth beacons, disclaimers on each webpage of the venue, etc. Content creation tools may inform users of policies and/or identify policies based on detecting logos and/or other identifiable features. Captured GPS location information may be used to help guide such determinations.

When matches are detected, prospective responses may include but are not limited to automated royalty payments, license offers, and/or facilitated payment back to the creators of the derivative work(s). In accordance with several embodiments, registered work sub-images can, alternatively or additionally, be automatically replaced by different images via image processing techniques. In such cases, the original derivative works may be replaced with the modified version. Similarly, music captured and/or infringed on may be modified and/or replaced using industry-standard audio manipulation tools.

Systems operating in accordance with several embodiments of the invention may automatically generate standard Digital Millennium Copyright Act (DMCA) and/or “take down” notices. Additionally or alternatively, notices may be sent to the entities (e.g., host sites) hosting and/or offering the derivative work(s). In accordance with some embodiments, records of the potential violations (and corresponding notifications) may be logged. Such logs may be located in, but are not limited to, private databases, public distributed ledgers, and/or blockchains. Reminder flags may, additionally or alternatively, be configured to check that the relevant content elements are no longer publicly available.

In accordance with numerous embodiments, prospective systems including but not limited to NFT marketplaces may be configured to automatically reject derivative works for listings. Additionally or alternatively, systems may inform the user of the reason(s) for the rejection.

Methods for detecting visual sub-components of derivative works may involve visual scene analysis including but not limited to segmentation, feature construction, and comparison with database(s) of registered images. Additionally or alternatively, techniques including but not limited to the use of Convolutional Neural Nets, YOLO/Darknet object detection systems, and other “Deep Learning” techniques may be employed. Methods for detecting visual sub-components of video may incorporate Time-Delay Neural Networks to add the dimension of time.

Methods for detecting audible sub-components of derivative works may be similarly varied. For example, audio (e.g., music) “fingerprinting” techniques may be used to determine when the backing audio track, or some sub-component of it, matches any such content which is registered on the media chains.

In various embodiments of the invention, certain features important for object recognition in computer scene analysis may be directly stored on media chains. Doing so may be used to make the search and recognition process more efficient. Various hashing techniques could be employed to further increase efficiency and/or reduce search time and computation. For example, in accordance with some embodiments, background music configurations can be reduced to sparse sets of spectral highlight markers derived from spectrograms. Once computed, these markers could be hashed, and stored on media chains.

In accordance with a number of embodiments, when derivative works are presented for inspection, stored and/or hashed features may be recovered to be compared with the feature vectors and/or vector descriptions of works registered on media chains. Entries for which hashed results match may be further verified relative to particular thresholds of certainty. Thresholds may be used to indicate use of the registered work within one or more derivative works. Likewise, low-level local image features including but not limited to scale-invariant feature transform (SIFT) can be computed in advance from images and other visual works. These features may then be stored for future comparisons. Additionally or alternatively, neural network approaches including but not limited to CNNs can be used to compute feature representations for arbitrary types of media, including but not limited to audio, images, and video.

In accordance with numerous embodiments, comparison mechanisms may take multiple forms. Comparisons can be verbatim, requiring a predetermined number of compared elements to be identical for a match to be determined. Additionally or alternatively, comparisons can determine whether a low number (e.g., one or two) of elements are part of one or more registered works. In such cases, matches may be concluded when the content inclusion is sufficiently long and/or large enough to suggest that a derivative work exists regardless. For example, a comparison may determine whether a given content string of least a minimum length, (e.g., 2 kilobytes, 2 seconds of playing, a sequence of five notes played) is part of another string. Comparisons may be performed using fuzzy comparison methods, including but not limited to machine learning (ML) based methods. Comparisons may be based on rules defining what standards for matches, including but not limited to similarity scores. Comparisons may, additionally or alternatively, rely on previously adjudicated examples (e.g., manual review) based on criteria that can then be optionally compiled into rules and policies. Additional comparison methods may involve but are not limited to string-matching techniques, techniques determining the linguistic meaning of text, techniques for determining the audio distance between two elements, techniques for determining the difference between Fast Fourier Transform (FFT), other transform representations of elements, etc.

Derivative works may include registered works in their entirety, in part, and/or under various transformations including but not limited to rotation, perspective skewing, etc. For example, systems operating in accordance with a number of embodiments may identify the image of a Nike shoe hanging on a wall, as captured by a photograph and/or video of an entire room. Similarly, a piece of registered artwork might hang on the wall and/or show on the side of a building which is included in a larger television scene. Similarly, a clip of music, registered spoken word poetry, and/or a segment of dialog from a movie may form all or part of the soundtrack of a video. Systems may thereby recognize these audio sub-segments (which came from registered works) and take appropriate actions as disclosed above.

In response to complex visual works, which may involve sub-components including but not limited to copyrighted works, trademarked logos, etc., derivative work images can be processed by image processing algorithms. Such algorithms may perform operations including but not limited to segmentation and object recognition. Identified sub-images (and/or features derived from them) can be submitted as queries to media chain lookup and matching mechanisms. where the lookup may access protected images. Such images, as suggested above, may be stored in databases.

In accordance with many embodiments, the registered work image and/or sub-image could be automatically blurred via image processing techniques, and the original derivative works replaced and/or amended with the modified version. Media-chains can, alternatively or additionally, replace the derivative images and/or sub-images with different content. Image and sub-image substitutes used for replacement purposes may be drawn from royalty-free collections. Additionally or alternatively, in accordance with some embodiments, substitute images may include logos and/or product placement for third-party advertising purposes.

In accordance with some embodiments, large collection of registered materials could be assembled from the media chain, and offered as a “catalog” of artwork components available for use and licensing. For example, video producer could go to the disclosed media chains registry catalog (Media Catalog), and browse pieces of art for use in their own productions. Such available art pieces could be organized by license and use type. For example: free with accreditation, fair use, structured royalty (per use, per view, per second, etc.).

As mentioned above, certain audiovisual (e.g., film, video) derivative content may incorporate sub-elements which may have been registered on media chains. Such sub-elements may include but are not limited to music, spoken word, sound effects, etc. In such cases, auditory scene analysis and/or music information retrieval may yield several “Audio Objects” (and/or features derived from them) that represent the derivative work. These derivative works may then be subjected to media chain lookups for potential matching with registered audio, music, speech and/or text entries. In accordance with a few embodiments, speech-to-text analysis can be used to determine when utterances express registered content, including but not limited to published poems and song lyrics. When matches are found, many of the same measures can be taken including but not limited to assessing and collecting royalties, offering licenses, issuing take-down notice(s), altering and replacing the audio content, etc.

Various embodiments of the invention may scan and analyze content and/or NFTs to determine when possible infringement exists. By doing so, users may compare their content to works registered on the media chain, taking appropriate actions when matches can be found. Some registered components on the media chain may themselves be NFTs and/or NFT sub-components.

While the above description contains many specific embodiments of the invention, these should not be construed as limitations on the scope of the invention, but rather as an example of one embodiment thereof. Accordingly, the scope of the invention should be determined not by the embodiments illustrated, but by the appended claims and their equivalents.

What is claimed is:

1. A method for assessing content similarity comprising:
receiving a record associated with a first content element, wherein the first content element is associated with an exclusion distance,
wherein the record comprises a first content description and a license indicator, and
wherein the first content description comprises a type indicator for the first content element and a first quantifier of the first content element; receiving a second content element;
generating a second content description from the second content element, wherein a type indicator for the second content element and a second quantifier of the second content element;
deriving a comparison distance between the first quantifier and the second quantifier; and
when the exclusion distance of the first content element exceeds the comparison distance, taking a remedial action for infringement.

2. The method of claim 1, wherein the remedial action is at least one of requiring a license to be created, blocking generation of a token from the second content element, updating a record for the second content element, limiting access to the second content element, initiating a review of the first and second content elements by an administrator, and allowing generation of a token from the second content element with an indication of the infringement.

3. The method of claim 1, wherein a quantifier is at least one of a vector representation of a content element and a string.

4. The method of claim 1, wherein the license indicator comprises terms associated with using the first content element.

5. The method of claim 1, type indicators correspond to classifications related to at least one of audio data, visual data and executable data.

6. The method of claim 1, wherein a quantifier is based, at least in part, on at least one of content volume, content colors, content rate, and content functionality.

7. The method of claim 1, wherein both the comparison distance and the exclusion distance of the first content element are at least one of a vector distance and a Hamming distance.

8. The method of claim 1, wherein the exclusion distance of the first content element is at least one of a value preset by an entity associated with the first content element and a value stored in the record.

9. The method of claim 2, wherein the remedial action is determined in an automated process.

10. The method of claim 1, further comprising: when the exclusion distance of the first content element does not exceed the comparison distance, associating the second content element with at least one of:
a verification that a license is not required; and
a second exclusion distance.

11. A non-transitory computer-readable medium storing instructions that, when executed by a processor, are configured to cause the processor to perform operations for assessing content similarity, the operations comprising:
receiving a record associated with a first content element, wherein the first content element is associated with an exclusion distance,
wherein the record comprises a first content description and a license indicator, and
wherein the first content description comprises a type indicator for the first content element and a first quantifier of the first content element;
receiving a second content element;
generating a second content description from the second content element, wherein a type indicator for the second content element and a second quantifier of the second content element;
deriving a comparison distance between the first quantifier and the second quantifier; and
when the exclusion distance of the first content element exceeds the comparison distance, taking a remedial action for infringement.

12. The non-transitory computer-readable medium of claim 11, wherein the remedial action is at least one of requiring a license to be created, blocking generation of a token from the second content element, updating a record for the second content element, limiting access to the second content element, initiating a review of the first and second content elements by an administrator, and allowing generation of a token from the second content element with an indication of the infringement.

13. The non-transitory computer-readable medium of claim 11, wherein a quantifier is at least one of a vector representation of a content element and a string.

14. The non-transitory computer-readable medium of claim 11, wherein the license indicator comprises terms associated with using the first content element.

15. The non-transitory computer-readable medium of claim 11, type indicators correspond to classifications related to at least one of audio data, visual data and executable data.

16. The non-transitory computer-readable medium of claim 11, wherein a quantifier is based, at least in part, on at least one of content volume, content colors, content rate, and content functionality.

17. The non-transitory computer-readable medium of claim 11, wherein both the comparison distance and the exclusion distance of the first content element are at least one of a vector distance and a Hamming distance.

18. The non-transitory computer-readable medium of claim 11, wherein the exclusion distance of the first content element is at least one of a value preset by an entity associated with the first content element and a value stored in the record.

19. The non-transitory computer-readable medium of claim 12, wherein the remedial action is determined in an automated process.

20. The non-transitory computer-readable medium of claim 11, further comprising: when the exclusion distance of the first content element does not exceed the comparison distance, associating the second content element with at least one of:
a verification that a license is not required; and
a second exclusion distance.
